(19) United States
(12) Patent Application Publication
(10) Pub. No.: US 2025/0035890 A1
(43) Pub. Date: Jan. 30, 2025

(54) OPTICAL LENS SYSTEM, IMAGING APPARATUS AND ELECTRONIC DEVICE

(71) Applicant: LARGAN PRECISION CO., LTD., Taichung City (TW)

(72) Inventors: Kuan-Ting YEH, Taichung City (TW); Shih-Han CHEN, Taichung City (TW); Yi-Cheng LIN, Taichung City (TW); Hsin-Hsuan HUANG, Taichung City (TW); Yu-Han SHIH, Taichung City (TW)

(21) Appl. No.: 18/679,864

(22) Filed: May 31, 2024

Related U.S. Application Data
(60) Provisional application No. 63/524,728, filed on Jul. 3, 2023.

(30) Foreign Application Priority Data
Jul. 26, 2023 (TW) 112127942

(51) Int. Cl. G02B 13/00; G02B 9/62

(52) U.S. Cl. CPC G02B 13/0045; G02B 9/62

(57) ABSTRACT

An optical lens system includes six lens elements from an object side to an image side, the six lens elements are, in order from the object side to the image side, a first lens element, a second lens element, a third lens element, a fourth lens element, a fifth lens element and a sixth lens element. Each of the six lens elements has an object-side surface towards the object side and an image-side surface towards the image side. The image-side surface of the second lens element is concave in a paraxial region thereof. The third lens element has positive refractive power. The image-side surface of the fourth lens element is concave in a paraxial region thereof. The image-side surface of the sixth lens element includes at least one inflection point.

### RELATED APPLICATIONS

This application claims priority to U.S. Provisional Application Ser. No. 63/524,728, filed Jul. 3, 2023, and Taiwan Application Serial Number 112127942, filed Jul. 26, 2023, which are herein incorporated by reference.

### BACKGROUND

### Technical Field

The present disclosure relates to an optical lens system and an imaging apparatus. More particularly, the present disclosure relates to an optical lens system and an imaging apparatus with compact size applicable to electronic devices.

### Description of Related Art

With recent technology of semiconductor process advances, performances of image sensors are enhanced, so that the smaller pixel size can be achieved. Therefore, optical lens assemblies with high image quality have become an indispensable part of many modern electronics. With rapid developments of technology, applications of the electronic devices equipped with optical lens systems become wider, and there is a bigger variety of requirements for the optical lens assemblies. In a conventional optical lens assembly, it is hard to balance among image quality, manufacturing sensitivity, aperture size, volume or field of view, so an optical lens assembly with high imaging quality is provided in the present disclosure to meet the requirements.

### SUMMARY

According to one aspect of the present disclosure, an optical lens system includes six lens elements from an object side to an image side, the six lens elements are, in order from the object side to the image side, a first lens element, a second lens element, a third lens element, a fourth lens element, a fifth lens element and a sixth lens element. Each of the six lens elements has an object-side surface towards the object side and an image-side surface towards the image side. Preferably, the image-side surface of the second lens element is concave in a paraxial region thereof. Preferably, the third lens element has positive refractive power. Preferably, the image-side surface of the fourth lens element is concave in a paraxial region thereof. Preferably, the image-side surface of the sixth lens element includes at least one inflection point. When a focal length of the optical lens system is f, a focal length of the first lens element is f1, a composite focal length of the first lens element and the second lens element is f12, a central thickness of the first lens element is CT1, an axial distance between the first lens element and the second lens element is T12, a curvature radius of the image-side surface of the fifth lens element is R10, a curvature radius of the object-side surface of the sixth lens element is R11, an axial distance between the object-side surface of the first lens element to the image-side surface of the sixth lens element is TD, and an axial distance between the object-side surface of the first lens element to an image surface is TL, the following conditions are preferably satisfied: 0.25<(CT1+T12)/TD<0.40; 0.20<R11/R10<3.30; 6.00<TL/f<13.00; −1.60<|R11|/f12<−0.50; and −6.40<f1/CT1<0.00.

According to the present disclosure, an imaging apparatus includes the aforementioned optical lens system and an image sensor, and the image sensor is disposed on the image surface of the optical lens system.

According to the present disclosure, an electronic device includes the aforementioned imaging apparatus.

According to another aspect of the present disclosure, an optical lens system includes six lens elements from an object side to an image side, the six lens elements are, in order from the object side to the image side, a first lens element, a second lens element, a third lens element, a fourth lens element, a fifth lens element and a sixth lens element. Each of the six lens elements has an object-side surface towards the object side and an image-side surface towards the image side. Preferably, the image-side surface of the second lens element is concave in a paraxial region thereof. Preferably, the third lens element with positive refractive power has the object-side surface being convex in a paraxial region thereof and the image-side surface being convex in a paraxial region thereof. Preferably, the image-side surface of the fourth lens element is concave in a paraxial region thereof. Preferably, the object-side surface of the fifth lens element is convex in a paraxial region thereof. Preferably, the image-side surface of the sixth lens element includes at least one inflection point. Preferably, there is an air gap on an optical axis between each of adjacent lens elements of the six lens elements. When a focal length of the optical lens system is f, a central thickness of the first lens element is CT1, an axial distance between the first lens element and the second lens element is T12, the axial distance between the second lens element and the third lens element is T23, the axial distance between the fourth lens element and the fifth lens element is T45, a curvature radius of the image-side surface of the fifth lens element is R10, a curvature radius of the object-side surface of the sixth lens element is R11, an axial distance between the object-side surface of the first lens element to the image-side surface of the sixth lens element is TD, and an axial distance between the object-side surface of the first lens element to an image surface is TL, the following conditions are preferably satisfied: 0.22<(CT1+T12)/TD<0.45; 0.20<R11/R10<1.50; 6.00<TL/f<13.00; and 0.04<T45/T23<1.10.

According to another aspect of the present disclosure, an optical lens system includes six lens elements from an object side to an image side, the six lens elements are, in order from the object side to the image side, a first lens element, a second lens element, a third lens element, a fourth lens element, a fifth lens element and a sixth lens element. Each of the six lens elements has an object-side surface towards the object side and an image-side surface towards the image side. Preferably, the image-side surface of the second lens element is concave in a paraxial region thereof. Preferably, the image-side surface of the third lens element is convex in a paraxial region thereof. Preferably, the image-side surface of the fourth lens element is concave in a paraxial region thereof. Preferably, the object-side surface of the fifth lens element is convex in a paraxial region thereof. Preferably, the image-side surface of the sixth lens element includes at least one inflection point. When a focal length of the optical lens system is f, a focal length of the first lens element is f1, a composite focal length of the first lens element and the second lens element is f12, a central thickness of the first lens element is CT1, a central thickness of the sixth lens element is CT6, an axial distance between the first lens element and the second lens element is T12, a curvature radius of the object-side surface of the sixth lens element is R11, an axial distance between the object-side surface of the first lens element to the image-side surface of the sixth lens element is TD, and an axial distance between the object-side surface of the first lens element to an image surface is TL, the following conditions are preferably satisfied: 0.25<(CT1+T12)/TD<0.40; −1.60<|R11|/f12<−0.50; 1.0<f/CT1<2.3; −0.40<f1/TL<0.00; and 10<TD/CT6<21.

### BRIEF DESCRIPTION OF THE DRAWINGS

The present disclosure can be more fully understood by reading the following detailed description of the embodiment, with reference made to the accompanying drawings as follows:

FIG. 1A is a schematic view of an imaging apparatus according to the 1st embodiment of the present disclosure.

FIG. 1B shows, in order from left to right, spherical aberration curves, astigmatic field curves and a distortion curve of the imaging apparatus according to the 1st embodiment.

FIG. 2A is a schematic view of an imaging apparatus according to the 2nd embodiment of the present disclosure.

FIG. 2B shows, in order from left to right, spherical aberration curves, astigmatic field curves and a distortion curve of the imaging apparatus according to the 2nd embodiment.

FIG. 3A is a schematic view of an imaging apparatus according to the 3rd embodiment of the present disclosure.

FIG. 3B shows, in order from left to right, spherical aberration curves, astigmatic field curves and a distortion curve of the imaging apparatus according to the 3rd embodiment.

FIG. 4A is a schematic view of an imaging apparatus according to the 4th embodiment of the present disclosure.

FIG. 4B shows, in order from left to right, spherical aberration curves, astigmatic field curves and a distortion curve of the imaging apparatus according to the 4th embodiment.

FIG. 5A is a schematic view of an imaging apparatus according to the 5th embodiment of the present disclosure.

FIG. 5B shows, in order from left to right, spherical aberration curves, astigmatic field curves and a distortion curve of the imaging apparatus according to the 5th embodiment.

FIG. 6A is a schematic view of an imaging apparatus according to the 6th embodiment of the present disclosure.

FIG. 6B shows, in order from left to right, spherical aberration curves, astigmatic field curves and a distortion curve of the imaging apparatus according to the 6th embodiment.

FIG. 7A is a schematic view of an imaging apparatus according to the 7th embodiment of the present disclosure.

FIG. 7B shows, in order from left to right, spherical aberration curves, astigmatic field curves and a distortion curve of the imaging apparatus according to the 7th embodiment.

FIG. 8A is a schematic view of part of parameters of the 1st embodiment.

FIG. 8B is a schematic view of inflection points and critical points of each lens element in the 1st embodiment.

FIG. 9 is a three-dimensional schematic view of an imaging apparatus according to the 8th embodiment of the present disclosure.

FIG. 10 is a schematic view of one side of an electronic device according to the 9th embodiment of the present disclosure.

FIG. 11 is a schematic view of one side of an electronic device according to the 10th embodiment of the present disclosure.

FIG. 12A is a schematic view of one side of an electronic device according to the 11th embodiment of the present disclosure.

FIG. 12B is a schematic view of another side of the electronic device of FIG. 12A.

FIG. 13 is a three-dimensional schematic view of an electronic device according to the 12th embodiment of the present disclosure.

FIG. 14 is a three-dimensional schematic view of an electronic device according to the 13th embodiment of the present disclosure.

FIG. 15 is a top view of a vehicle device according to the 14th embodiment of the present disclosure.

FIG. 16A is a schematic view of an arrangement of a light path folding element in the optical lens system of the present disclosure.

FIG. 16B is a schematic view of another arrangement of the light path folding element in the optical lens system of the present disclosure.

FIG. 16C is a schematic view of an arrangement of two light path folding elements in the optical lens system of the present disclosure.

### DETAILED DESCRIPTION

According to the present disclosure, an optical lens system includes six lens elements from an object side to an image side. The six lens elements are, in order from the object side to the image side, a first lens element, a second lens element, a third lens element, a fourth lens element, a fifth lens element and a sixth lens element. Each of the six lens elements has an object-side surface towards the object side and an image-side surface towards the image side.

The first lens element can have negative refractive power, which is favorable for light convergence to increase the field of view, and is favorable for adjusting the refractive power arrangement of the optical lens system. The image-side surface of the first lens element can be concave in a paraxial region thereof. It can adjust the passing direction of light, which is favorable for receiving the light path in a wider field of view, and simultaneously reduce the generation of astigmatism.

The image-side surface of the second lens element is concave in a paraxial region thereof. It can lead the light path, which prevents total reflection resulted from large folding angle, and simultaneously corrects spherical aberration accumulated in the front of the optical lens system to enhance the imaging quality.

The third lens element can have positive refractive power, which is favorable for light convergence and effectively control light path to reduce the back focal length and reduce the volume of the optical lens system. The object-side surface of the third lens element can be convex in a paraxial region thereof, which is favorable for correcting axis aberrations, and simultaneously balancing the aberrations such as spherical aberration, comatic aberration, etc. caused by compressing the volume. The image-side surface of the third lens element can be convex in a paraxial region thereof. It can make light to converge, which is favorable for reducing the total length of the optical lens system, and simultaneously correcting the aberrations.

The image-side surface of the fourth lens element is concave in a paraxial region thereof. It can adjust the emerging direction of light at the fourth lens element, which is favorable for enhancing the illumination and correcting spherical aberration. Moreover, the image-side surface of the fourth lens element includes at least one inflection point. It can enrich the surface shape change of the image-side surface of the fourth lens element, control emerging light at the peripheral region of the fourth lens element, and reduce off-axis aberration.

The object-side surface of the fifth lens element can be convex in a paraxial region thereof. It can adjust the surface shape and refractive power of the fifth lens element, which is favorable for correcting astigmatism and distortion.

The image-side surface of the sixth lens element includes at least one inflection point. It can make the surface shape of the image-side surface of the sixth lens element have positive and negative change on curvature radius, which effectively reduces the back focal length of the optical lens system, controls the total length of the optical lens system, and is simultaneously favorable for correction and compensation of field curvature of the peripheral image. Moreover, the object-side surface of the sixth lens element can include at least one inflection point. It can enhance the flexibility of designing the sixth lens element, which is favorable for correcting astigmatism and overall curvature of imaging surface accumulated by the optical lens system.

The image-side surface of the sixth lens element can include at least one concave critical point, which is favorable for controlling the angle of light at the peripheral region, and further reducing the total length of the optical lens system to prevent vignetting from generating at the peripheral region of the image and reduce distortion.

There is an air gap on an optical axis between each of adjacent lens elements of the six lens elements, which is favorable for increasing the flexibility of designing the surface shape of lens element, and obtaining the balance between the total length and imaging quality of the optical lens system. Moreover, at least two of the six lens elements are made of plastic material. It can reduce the manufacturing cost, and easily fit the design of aspheric surface shape to reduce the manufacturing tolerance. The object-side surface and the image-side surface of each of at least two of the six lens elements are aspheric. It can enhance the flexibility of designing the lens elements, which is favorable for reducing the volume of the optical lens system and enhancing the imaging quality.

When a central thickness of the first lens element is CT1, an axial distance between the first lens element and the second lens element is T12, wherein in the present disclosure, an axial distance between two adjacent lens elements is an axial distance between two adjacent lens surfaces of the two adjacent lens elements, and an axial distance between the object-side surface of the first lens element to the image-side surface of the sixth lens element is TD, the following condition is satisfied: 0.22<(CT1+T12)/TD<0.45. Therefore, the central thickness of the first lens element and the distance between the first lens element and the second lens element can be controlled, which is favorable for obtaining the balance between adjusting the direction of light path and the volume of the lens assembly. Moreover, the following condition can be satisfied: 0.25<(CT1+T12)/TD<0.40. Moreover, the following condition can be satisfied: 0.28≤(CT1+T12)/TD≤0.37.

When a curvature radius of the image-side surface of the fifth lens element is R10, and a curvature radius of the object-side surface of the sixth lens element is R11, the following condition is satisfied: 0.20<R11/R10<3.30. Therefore, the ratio of the curvature radius of the image-side surface of the fifth lens element and the curvature radius of the object-side surface of the sixth lens element can be adjusted, which is favorable for improving astigmatism and chromatic aberration of magnification. Moreover, the following condition can be satisfied: 0.20<R11/R10<1.50. Moreover, the following condition can be satisfied: 0.30<R11/R10<2.20. Moreover, the following condition can be satisfied: 0.30<R11/R10<1.15. Moreover, the following condition can be satisfied: 0.39≤R11/R10≤0.96.

When a focal length of the optical lens system is f, and an axial distance between the object-side surface of the first lens element to an image surface is TL, the following condition is satisfied: 6.00<TL/f<13.00. Therefore, it is favorable for obtaining the balance between the overall refractive power and volume of the optical lens system, and effectively controlling the total length thereof. Moreover, the following condition can be satisfied: 6.50<TL/f<9.50. Moreover, the following condition can be satisfied: 6.74≤TL/f≤10.11.

When the curvature radius of the object-side surface of the sixth lens element is R11, and a composite focal length of the first lens element and the second lens element is f12, the following condition is satisfied: −1.60<|R11|/f12<−0.50. Therefore, the surface shape of the object-side surface of the sixth lens element can be designed, which is favorable for correcting astigmatism of the optical lens system and reducing the stray light in the optical lens system. Moreover, the following condition can be satisfied: −1.45<|R11|/f12<−0.65. Moreover, the following condition can be satisfied: −1.16≤|R11|/f12≤−0.67.

When a focal length of the first lens element is f1, and the central thickness of the first lens element is CT1, the following condition is satisfied: −6.40<f1/CT1<0.00. Therefore, it is favorable for adjusting the surface shape and refractive power of the object-side surface of the first lens element to compress the volume, and simultaneously reducing the generation of spherical aberration to enhance the imaging quality. Moreover, the following condition can be satisfied: −5.50<f1/CT1<−2.00. Moreover, the following condition can be satisfied: −5.00<f1/CT1<−2.50. Moreover, the following condition can be satisfied: −4.72≤f1/CT1≤−2.85.

When an axial distance between the second lens element and the third lens element is T23, and an axial distance between the fourth lens element and the fifth lens element is T45, the following condition is satisfied: 0.04<T45/T23<1.10. Therefore, the ratio of the distance between the fourth lens element and the fifth lens element and the distance between the second lens element and the third lens element can be controlled, which is favorable for reducing the sensitivity during manufacturing and simultaneously correcting aberration. Moreover, the following condition can be satisfied: 0.05<T45/T23<1.00. Moreover, the following condition can be satisfied: 0.06≤T45/T23≤0.28.

When the focal length of the optical lens system is f, and the central thickness of the first lens element is CT1, the following condition is satisfied: 1.0<f/CT1<2.3. Therefore, the ratio value of the focal length of the optical lens system and the central thickness of the first lens element can be effectively adjusted to compress the volume of the optical lens system. Moreover, the following condition can be satisfied: 1.1<f/CT1<2.1. Moreover, the following condition can be satisfied: 1.30≤f/CT1≤2.02.

When the focal length of the first lens element is f1, and the axial distance between the object-side surface of the first lens element to the image surface is TL, the following condition is satisfied: −0.40<f1/TL<0.00. Therefore, through the refractive power of the first lens element, the total length of the optical lens system is balanced to prevent the total length thereof from being too long. Moreover, the following condition can be satisfied: −0.35<f1/TL<−0.2. Moreover, the following condition can be satisfied: −0.29≤f1/TL≤−0.25.

When the axial distance between the object-side surface of the first lens element to the image-side surface of the sixth lens element is TD, and a central thickness of the sixth lens element is CT6, the following condition is satisfied: 10<TD/CT6<21. Therefore, through changing the ratio relationship between the central thickness of the sixth lens element and the length of lens assembly, the volume of the optical lens system is compressed. Moreover, the following condition can be satisfied: 10<TD/CT6<18. Moreover, the following condition can be satisfied: 12.16≤TD/CT6≤16.65.

When the curvature radius of the object-side surface of the sixth lens element is R11, and a curvature radius of the image-side surface of the sixth lens element is R12, the following condition is satisfied: 0.9<|R12/R11|<20.0. Through adjusting the surface shape of the sixth lens element, the overall curvature of imaging surface of the optical lens system can be corrected. Moreover, the following condition can be satisfied: 1.0<|R12/R11|<18.0.

When the axial distance between the fourth lens element and the fifth lens element is T45, and an axial distance between the fifth lens element and the sixth lens element is T56, the following condition is satisfied: 0.05<T56/T45<10.00. Therefore, the ratio of the distance between the fifth lens element and the sixth lens element and the distance between the fourth lens element and the fifth lens element can be controlled, which is favorable for reducing the manufacturing tolerance and enhancing the yield. Moreover, the following condition can be satisfied: 0.30<T56/T45<6.50. Moreover, the following condition can be satisfied: 0.30<T56/T45<3.00.

When the focal length of the first lens element is f1, and an axial distance between the image-side surface of the sixth lens element and the image surface is BL, the following condition is satisfied: −2.60<f1/BL<0.00. Therefore, the back focal length of the optical lens system can be effectively controlled, the volume of the optical lens system is reduced, and that the first lens element has a certain refractive power is ensured. Moreover, the following condition can be satisfied: −2.00<f1/BL<−0.50.

When a central thickness of the second lens element is CT2, and a central thickness of the fourth lens element is CT4, the following condition is satisfied: 0.65<CT2/CT4<1.70. Therefore, the ratio of the central thickness of the second lens element and the central thickness of the fourth lens element can be adjusted, which is favorable for enhancing the efficiency of utilizing the spaces, and simultaneously increasing the symmetry of the optical lens system. Moreover, the following condition can be satisfied: 0.70<CT2/CT4<1.60.

The optical lens system can further include an aperture stop, which can be disposed between the second lens element and the third lens element. Therefore, the position of the aperture stop can be controlled and the incident angle of incident light can be limited, which is favorable for improving the imaging quality.

When an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the sixth lens element is V6, and a minimum among V1, V2, V3, V4, V5, V6 is Vmin, the following condition is satisfied: 8.0≤Vmin≤22.0. Therefore, the material arrangement of the lens elements can be adjusted and the chromatic aberration generated by the optical lens system can be corrected, which is favorable for improving the imaging quality. Moreover, the following condition can be satisfied: 10.0≤Vmin≤20.5.

When a curvature radius of the image-side surface of the third lens element is R6, and a curvature radius of the image-side surface of the fourth lens element is R8, the following condition is satisfied: −20.00<R6/R8<−0.20. Therefore, the surface shapes of the third lens element and the fourth lens element can be effectively balanced, and the light path of the optical lens system is adjusted to mutually balance aberration and improve imaging quality. Moreover, the following condition can be satisfied: −8.00<R6/R8<−0.30.

When a distance in parallel with the optical axis from an axial vertex on the object-side surface of the first lens element to a maximum effective radius position on the object-side surface of the first lens element is SAG1R1, and a distance in parallel with the optical axis from an axial vertex on the image-side surface of the first lens element to a maximum effective radius position on the image-side surface of the first lens element is SAG1R2, the following condition is satisfied: 1.00<SAG1R2/SAG1R1<4.50. Therefore, the curvature degree of surface shapes at the peripheral regions of the object-side surface and the image-side surface of the first lens element can be controlled, which is favorable for ensuring that light converges at larger field of view, the outer diameter at the object side of the optical lens system is reduced, and the comatic aberration is corrected. Moreover, the following condition can be satisfied: 1.50<SAG1R2/SAG1R1<3.75.

When a maximum effective radius of the object-side surface of the first lens element is Y1R1, and a maximum effective radius of the object-side surface of the second lens element is Y2R1, the following condition is satisfied: 1.60<Y1R1/Y2R1<4.50. Therefore, the heights of the maximum effective radii of the first lens element and the second lens element can be balanced, which is favorable for enlarging the field of view and compressing the volume. Moreover, the following condition can be satisfied: 1.80<Y1R1/Y2R1<4.00.

When a distance in parallel with the optical axis between a maximum effective radius position of an optically effective area of the object-side surface of the first lens element to a maximum effective radius position of an optically effective area of the image-side surface of the first lens element is ET1, and a distance in parallel with the optical axis between a maximum effective radius position of an optically effective area of the object-side surface of the fifth lens element to a maximum effective radius position of an optically effective area of the image-side surface of the fifth lens element is ET5, the following condition is satisfied: 1.50<ET1/ET5<5.00. Therefore, the ratio of the peripheral thickness of the first lens element and the peripheral thickness of the fifth lens element is controlled, which is favorable for balancing the light paths at the peripheral regions of the front end and rare end of the optical lens system. Moreover, the following condition can be satisfied: 1.70<ET1/ET5<4.50.

When the curvature radius of the image-side surface of the fourth lens element is R8, and a curvature radius of the object-side surface of the fifth lens element is R9, the following condition is satisfied: 0.20<R8/R9<2.50. Therefore, the fourth lens element and the fifth lens element can be cooperated with each other so as to enhance the ability of controlling light path by the lens elements, and solve the problem of distortion. Moreover, the following condition can be satisfied: 0.20<R8/R9<1.50.

When the axial distance between the object-side surface of the first lens element to the image surface is TL, and a maximum image height of the optical lens system is ImgH, the following condition is satisfied: 2.50<TL/ImgH<5.50. Therefore, it is favorable for obtaining balance between the compression of total length and enlargement of the image surface so as to satisfy various applications. Moreover, the following condition can be satisfied: 3.00<TL/ImgH<5.00.

When a distance in parallel with the optical axis between a maximum effective radius position of an optically effective area of the object-side surface of the fourth lens element to a maximum effective radius position of an optically effective area of the image-side surface of the fourth lens element is ET4, and the central thickness of the fourth lens element is CT4, the following condition is satisfied: 0.75<ET4/CT4<2.00. Therefore, the ratio between the peripheral thickness and central thickness of the fourth lens element can be adjusted, and that there is sufficient distance for peripheral light path to transmit is ensured, which is favorable for enlarging the images. Moreover, the following condition can be satisfied: 0.80<ET4/CT4<1.80.

When the maximum image height of the optical lens system is ImgH, which can be half of the diagonal length of the effective sensing region of an image sensor, and a maximum effective radius of the image-side surface of the sixth lens element is Y6R2, the following condition is satisfied: 1.20<ImgH/Y6R2<2.20. Therefore, the optical effective radius of the image-side surface of the sixth lens element can be adjusted, which is favorable for enlarging the size of image. Moreover, the following condition can be satisfied: 1.30<ImgH/Y6R2<2.00.

When the focal length of the optical lens system is f, and half of a maximum field of view of the optical lens system is HFOV, the following condition is satisfied: 0.0 mm<f/tan (HFOV)<1.0 mm. Therefore, the optical lens system can have sufficient imaging area, and the aberrations resulting from large field of view, such as distortion, are prevented. Moreover, the following condition can be satisfied: 0.0 mm<f/tan (HFOV)<0.6 mm.

When an f-number of the optical lens system is Fno, the following condition is satisfied: 1.5<Fno<2.1. Therefore, the size of the aperture stop can be controlled to meet the requirements of light passing hole diameter of the applied apparatus, and the amount of light entering the optical lens system is ensured to enhance the brightness of image. Moreover, the following condition can be satisfied: 1.65<Fno<2.0.

When the composite focal length of the first lens element and the second lens element is f12, and the axial distance between the image-side surface of the sixth lens element and the image surface is BL, the following condition is satisfied: −1.5<f12/BL<−0.1. Therefore, it is favorable for balancing the ratio of the refractive power at the front end of the optical lens system and the back focal length thereof, and making the refractive power at the front end of the optical lens system fall into a suitable region. Moreover, the following condition can be satisfied: −1.2<f12/BL<−0.3.

When the curvature radius of the object-side surface of the sixth lens element is R11, and the curvature radius of the image-side surface of the sixth lens element is R12, the following condition is satisfied: −35<(R11+R12)/(R11−R12)<0.5. Therefore, the surface shapes of the object-side surface and the image-side surface of the sixth lens element can be controlled, which is favorable for reducing the back focal length. Moreover, the following condition can be satisfied: −25<(R11+R12)/(R11−R12)<0.

When the Abbe number of the second lens element is V2, and the Abbe number of the third lens element is V3, the following condition is satisfied: 0.75<V2/V3<1.32. Therefore, the front light path of the optical lens system can be adjusted, the abilities of convergence between lights with different wavelength ranges are balanced and the chromatic aberration is corrected to improve the imaging quality. Moreover, the following condition can be satisfied: 0.85<V2/V3<1.12.

Each of the aforementioned features of the optical lens system can be utilized in various combinations for achieving the corresponding effects.

According to the optical lens system of the present disclosure, the lens elements thereof can be made of glass or plastic materials. When the lens elements are made of glass materials, the distribution of the refractive power of the optical lens system may be more flexible to design. The glass lens element can either be made by grinding or molding. When the lens elements are made of plastic materials, manufacturing costs can be effectively reduced. Furthermore, surfaces of each lens element can be arranged to be spherical or aspheric (ASP), wherein it is easier to fabricate the spherical surface. If the surfaces are arranged to be aspheric, more controllable variables can be obtained for eliminating aberrations thereof, and to further decrease the required amount of lens elements in the optical lens system. Therefore, the total track length of the optical lens system can also be reduced. The aspheric surfaces may be formed by plastic injection molding or glass molding.

According to the optical lens system of the present disclosure, one or more of the lens material may optionally include an additive which provides light absorption or light interference so as to alter the lens transmittance in a specific range of wavelength for reducing unwanted stray light or color deviation. For example, the additive may optionally filter out light in the wavelength range of 600 nm-800 nm for reducing excessive red light and/or near infra-red light, or may optionally filter out light in the wavelength range of 350 nm-450 nm to reduce excessive blue light and/or near ultra-violet light from interfering the final image. The additive may be homogenously mixed with plastic material to be used in manufacturing a mixed-material lens element by injection molding. Furthermore, the additive may be added in the coating on the lens element surface to achieve the aforementioned effects.

According to the optical lens system of the present disclosure, when a surface of a lens element is aspheric, it indicates that the surface has an aspheric shape throughout its optically effective area or a portion(s) thereof.

According to the optical lens system of the present disclosure, when the lens element has a convex surface, it indicates that the surface can be convex in the paraxial region thereof. When the lens element has a concave surface, it indicates that the surface can be concave in the paraxial region thereof. According to the optical lens system of the present disclosure, the refractive power or the focal length of a lens element being positive or negative may refer to the refractive power or the focal length in a paraxial region of the lens element.

According to the optical lens system of the present disclosure, a critical point is a non-axial point of the lens surface where its tangent is perpendicular to the optical axis; an inflection point is a point on a lens surface with a curvature changing from positive to negative or from negative to positive.

According to the optical lens system of the present disclosure, the image surface of the optical lens system, based on the corresponding image sensor, can be planar or curved. In particular, the image surface can be a concave curved surface facing towards the object side. According to the optical lens system of the present disclosure, at least one image correcting element (such as a field flattener) can be selectively disposed between the lens element closest to the image side of the optical lens system and the image surface on an imaging optical path so as to correct the image (such as the field curvature). Properties of the image correcting element, such as curvature, thickness, refractive index, position, surface shape (convex/concave, spherical/aspheric, diffractive and Fresnel, etc.) can be adjusted according to the requirements of the imaging apparatus. In general, the image correcting element is preferably a thin plano-concave element having a concave surface towards the object side and is disposed close to the image surface.

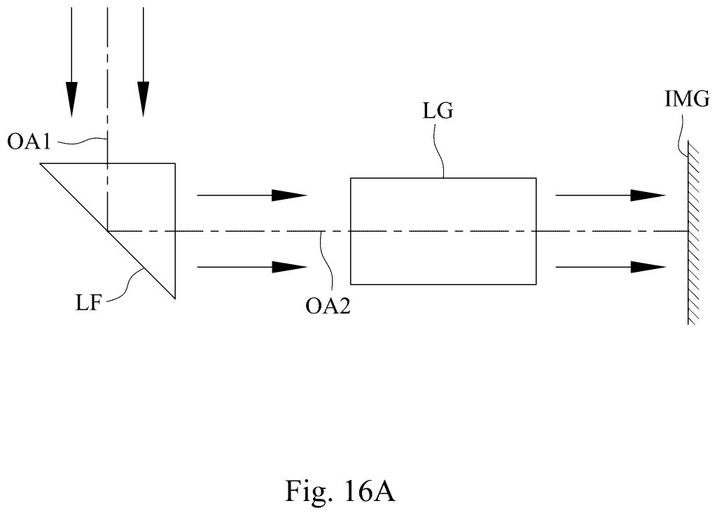

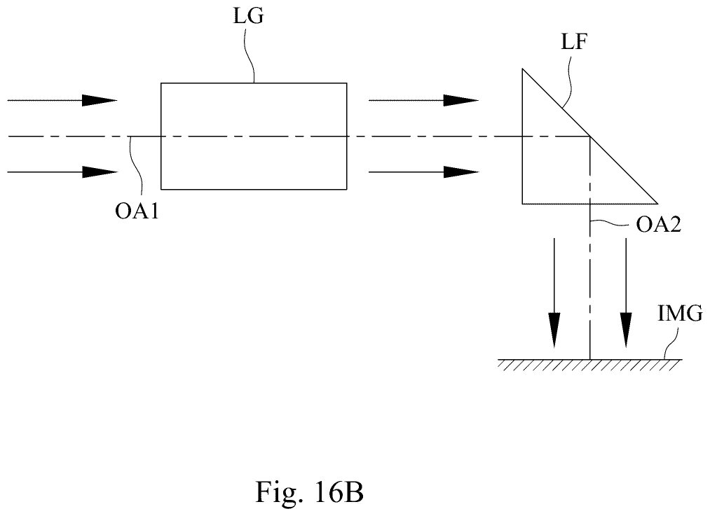

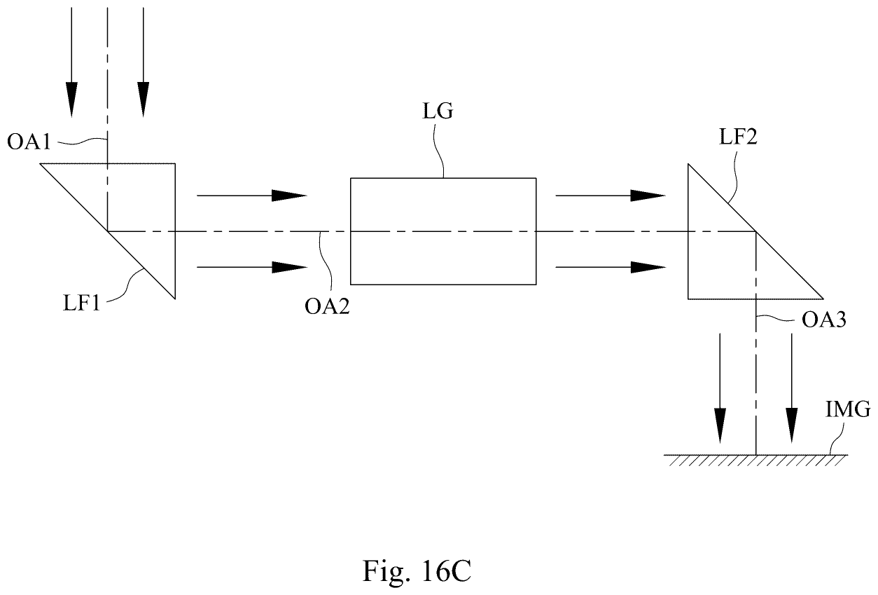

According to the optical lens system of the present disclosure, at least one element with light path folding function can be selectively disposed between the imaged object and the image surface, such as a prism or a mirror, wherein the prism surface or the mirror surface can be a planar surface, a spherical surface, an aspheric surface or a freeform surface. Therefore, it is favorable for providing high flexible space arrangement of the optical lens system, so that the compactness of the electronic device would not be restricted by the optical total track length of the optical lens system. FIG. 16A is a schematic view of an arrangement of a light path folding element LF in the optical lens system of the present disclosure. FIG. 16B is a schematic view of another arrangement of the light path folding element LF in the optical lens system of the present disclosure. As shown in FIG. 16A and FIG. 16B, the optical lens system includes, in order from an imaged object (not shown in drawings) to an image surface IMG, a first optical axis OA1, the light path folding element LF and a second optical axis OA2, wherein the light path folding element LF can be disposed between the imaged object and a lens group LG of the optical lens system as shown in FIG. 16A, or can be disposed between the lens group LG of the optical lens system and the image surface IMG as shown in FIG. 16B. Moreover, FIG. 16C is a schematic view of an arrangement of two light path folding elements LF1, LF2 in the optical lens system of the present disclosure. As shown in FIG. 16C, the optical lens system includes, in order from an imaged object (not shown in drawings) to an image surface IMG, a first optical axis OA1, the light path folding element LF1, a second optical axis OA2, the light path folding element LF2 and a third optical axis OA3, wherein the light path folding element LF1 is disposed between the imaged object and a lens group LG of the optical lens system, and the light path folding element LF2 is disposed between the lens group LG of the optical lens system and the image surface IMG. The optical lens system can also be selectively disposed with three or more light path folding elements, the type, amount and location of the light path folding elements will not be limited to the present disclosure.

According to the optical lens system of the present disclosure, the optical lens system can include at least one stop, such as an aperture stop, a glare stop or a field stop. Said glare stop or said field stop is for eliminating the stray light and thereby improving the image resolution thereof.

According to the optical lens system of the present disclosure, an aperture stop can be configured as a front stop or a middle stop. A front stop disposed between the imaged object and the first lens element can provide a longer distance between an exit pupil of the optical lens system and the image surface, and thereby obtains a telecentric effect and improves the image-sensing efficiency of the image sensor, such as CCD or CMOS. A middle stop disposed between the first lens element and the image surface is favorable for enlarging the field of view of the optical lens system and thereby provides a wide field of view for the same.

According to the optical lens system of the present disclosure, an aperture adjusting unit can be properly configured. The aperture adjusting unit can be a mechanical part or a light control part, and the dimension and the shape of the aperture adjusting unit can be electrically controlled. The mechanical part can include a moveable component such as a blade group or a shielding plate. The light control part can include a screen component such as a light filter, electrochromic material, a liquid crystal layer or the like. The amount of incoming light or the exposure time of the image can be controlled by the aperture adjusting unit to enhance the image moderation ability. In addition, the aperture adjusting unit can be the aperture stop of the optical lens system according to the present disclosure so as to moderate the image properties such as depth of field or the exposure speed by changing f-number.

According to the optical lens system of the present disclosure, one or more optical element can be properly configured so as to limit the way of light passing through the optical lens system. The aforementioned optical element can be a filter, a polarizer, etc., and it is not limited thereto. Moreover, the aforementioned optical element can be a single piece of element, a complex assembly or presented in a form of membrane, which is not limited thereto. The aforementioned optical element can be disposed at the object side, at the image side or between the lens elements of the optical lens system so as to allow the specific light to pass through, which will meet the requirements of applications.

According to the optical lens system of the present disclosure, the optical lens system can include at least one optical lens element, optical element or carrier, and at least one surface thereof includes a low-reflective layer. The stray light caused by the light reflecting at the interface can be effectively reduced by the low-reflective layer. The low-reflective layer can be disposed at the non-effective area of the object-side surface, at the non-effective area of the image-side surface or at the surface connecting the object-side surface and the image-side surface of the optical lens element. The optical element can be a light blocking element, an annular spacing element, a barrel member, a cover glass, a blue glass, a filter, a color filter, a light path folding element, a prism or a mirror, etc. The carrier can be a lens carrier for the lens assembly, a micro lens disposed on the image sensor, peripheral components of the image sensor substrate or a glass for protecting the image sensor, etc.

According to the optical lens system of the present disclosure, the optical lens system can be utilized in 3D (three-dimensional) image capturing applications, in products such as digital cameras, mobile devices, digital tablets, smart TVs, surveillance systems, motion sensing input devices, driving recording systems, rearview camera systems, wearable devices, and unmanned aerial vehicles.

According to the present disclosure, an imaging apparatus is provided. The imaging apparatus includes the aforementioned optical lens system and an image sensor, wherein the image sensor is disposed on the image surface of the aforementioned optical lens system. Through the surface shape arrangement of the lens elements in the optical lens system, it is favorable for obtaining balance between adjusting light path and the volume of the optical lens system, and the high imaging quality is provided and the compactness thereof is maintained. Preferably, the imaging apparatus can further include a barrel member, a holder member or a combination thereof.

According to the present disclosure, an electronic device is provided, wherein the electronic device includes the aforementioned imaging apparatus. Therefore, it is favorable for enhancing the image quality. Preferably, the electronic device can further include, but not limited to, a control unit, a display, a storage unit, a random access memory unit (RAM) or a combination thereof.

According to the above description of the present disclosure, the following specific embodiments are provided for further explanation.

### 1st Embodiment

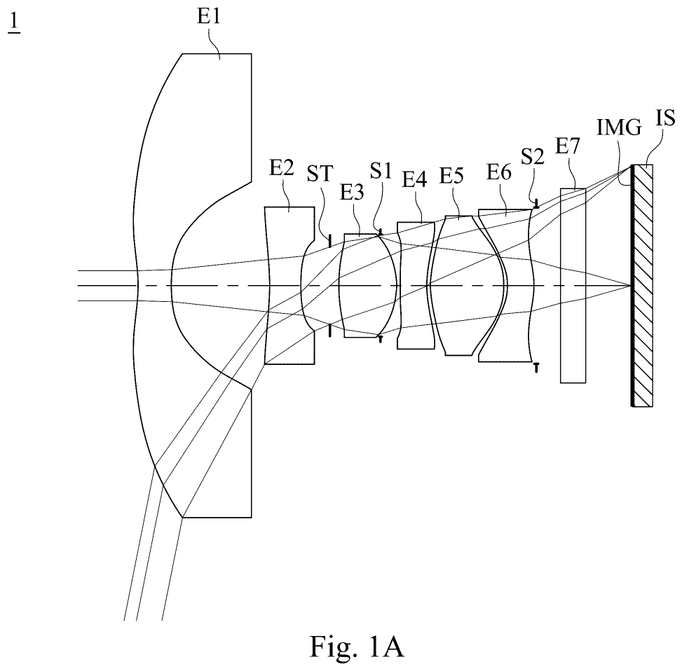

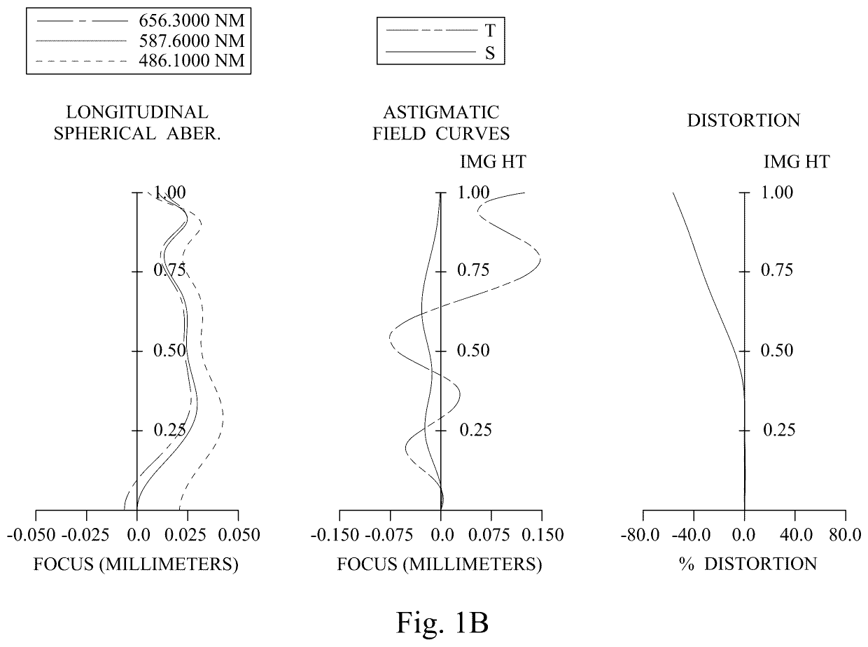

FIG. 1A is a schematic view of an imaging apparatus 1 according to the 1st embodiment of the present disclosure. FIG. 1B shows, in order from left to right, spherical aberration curves, astigmatic field curves and a distortion curve of the imaging apparatus 1 according to the 1st embodiment. In FIG. 1A, the imaging apparatus 1 according to the 1st embodiment includes an optical lens system (its reference number is omitted) and an image sensor IS. The optical lens system includes, in order from an object side to an image side along an optical path, a first lens element E1, a second lens element E2, an aperture stop ST, a third lens element E3, a stop S1, a fourth lens element E4, a fifth lens element E5, a sixth lens element E6, a stop S2, a filter E7 and an image surface IMG, wherein the image sensor IS is disposed on the image surface IMG of the optical lens system. The optical lens system includes six lens elements (E1, E2, E3, E4, E5, E6) without additional one or more lens elements inserted between the first lens element E1 and the sixth lens element E6.

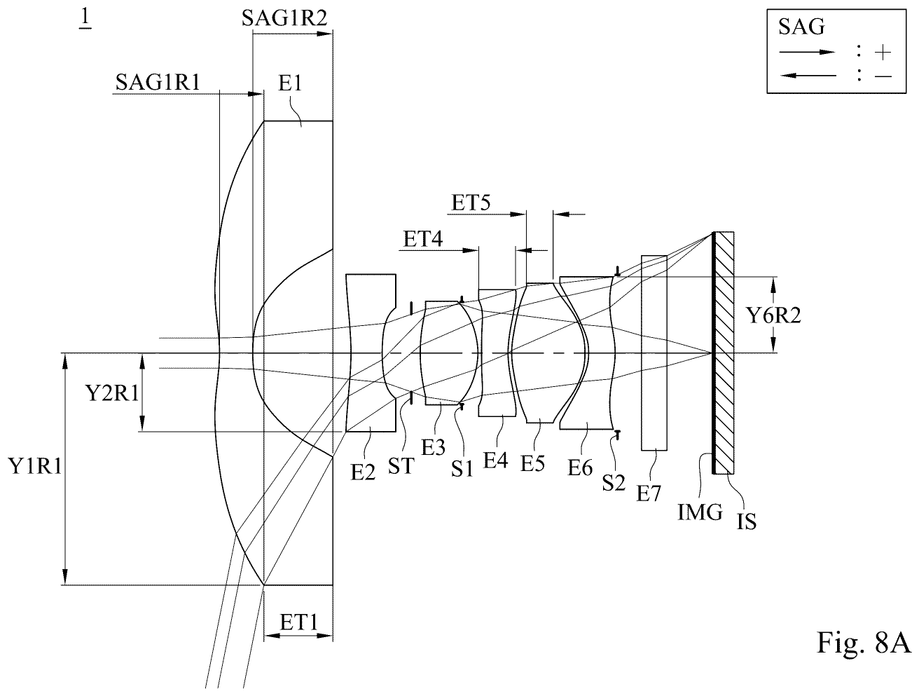

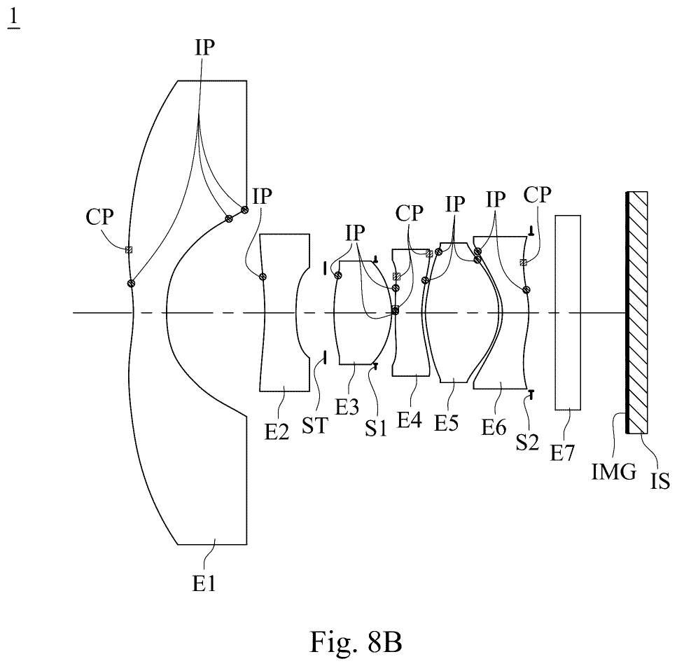

The first lens element E1 with negative refractive power has an object-side surface being concave in a paraxial region thereof and an image-side surface being concave in a paraxial region thereof. The first lens element E1 is made of plastic material, and has the object-side surface and the image-side surface being both aspheric. Moreover, FIG. 8B is a schematic view of inflection points IP and critical points CP of each lens element in the 1st embodiment. The object-side surface of the first lens element E1 includes one inflection point IP (shown in FIG. 8B) and one critical point CP (shown in FIG. 8B), the image-side surface of the first lens element E1 includes two inflection points IP (shown in FIG. 8B).

The second lens element E2 with negative refractive power has an object-side surface being concave in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes one inflection point IP (shown in FIG. 8B).

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes one inflection point IP (shown in FIG. 8B).

The fourth lens element E4 with negative refractive power has an object-side surface being concave in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes two inflection points IP (shown in FIG. 8B) and two critical points CP (shown in FIG. 8B), the image-side surface of the fourth lens element E4 includes one inflection point IP (shown in FIG. 8B) and one critical point CP (shown in FIG. 8B).

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Moreover, the object-side surface of the fifth lens element E5 includes one inflection point IP (shown in FIG. 8B), the image-side surface of the fifth lens element E5 includes one inflection point IP (shown in FIG. 8B).

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Moreover, the object-side surface of the sixth lens element E6 includes one inflection point IP (shown in FIG. 8B), the image-side surface of the sixth lens element E6 includes one inflection point IP (shown in FIG. 8B) and one critical point CP (shown in FIG. 8B).

The filter E7 is made of glass material and disposed between the sixth lens element E6 and the image surface IMG and will not affect a focal length of the optical lens system.

The equation of the aspheric surface profiles of the aforementioned lens elements is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times * ( {Y}^{i} ) ;$$

wherein,
X is a displacement in parallel with an optical axis from the intersection point of the aspheric surface and the optical axis to a point at a distance Y from the optical axis on the aspheric surface;
Y is the vertical distance from the point on the aspheric surface to the optical axis;
R is the curvature radius;
k is the conic coefficient; and
Ai is the i-th aspheric coefficient.

In the optical lens system according to the 1st embodiment, when the focal length of the optical lens system is f, an f-number of the optical lens system is Fno, and half of a maximum field of view of the optical lens system is HFOV, these parameters have the following values: f=0.45 mm; Fno=1.80; and HFOV=78.8 degrees.

In the optical lens system according to the 1st embodiment, when the maximum field of view of the optical lens system is FOV, the following condition is satisfied: FOV=157.6 degrees.

In the optical lens system according to the 1st embodiment, when an axial distance between the object-side surface of the first lens element E1 to the image surface IMG is TL, and a maximum image height of the optical lens system is ImgH, the following condition is satisfied: TL/ImgH=4.13.

In the optical lens system according to the 1st embodiment, when the focal length of the optical lens system is f, and the half of a maximum field of view of the optical lens system is HFOV, the following condition is satisfied: f/tan (HFOV)=0.09 mm.

In the optical lens system according to the 1st embodiment, when the axial distance between the object-side surface of the first lens element E1 to the image surface IMG is TL, and the focal length of the optical lens system is f, the following condition is satisfied: TL/f=9.13.

In the optical lens system according to the 1st embodiment, when a focal length of the first lens element E1 is f1, and an axial distance between the image-side surface of the sixth lens element E6 and the image surface IMG is BL, the following condition is satisfied: f1/BL=−1.44.

In the optical lens system according to the 1st embodiment, when the focal length of the optical lens system is f, and a central thickness of the first lens element E1 is CT1, the following condition is satisfied: f/CT1=1.63.

In the optical lens system according to the 1st embodiment, when the focal length of the first lens element E1 is f1, and the axial distance between the object-side surface of the first lens element E1 to the image surface IMG is TL, the following condition is satisfied: f1/TL=−0.29.

In the optical lens system according to the 1st embodiment, when a composite focal length of the first lens element E1 and the second lens element E2 is f12, the axial distance between the image-side surface of the sixth lens element E6 and the image surface IMG is BL, and a curvature radius of the object-side surface of the sixth lens element E6 is R11, the following conditions are satisfied: f12/BL=−0.61; and |R11|/f12=−1.16.

In the optical lens system according to the 1st embodiment, when the focal length of the first lens element E1 is f1, and the central thickness of the first lens element E1 is CT1, the following condition is satisfied: f1/CT1=−4.28.

In the optical lens system according to the 1st embodiment, when a curvature radius of the image-side surface of the third lens element E3 is R6, a curvature radius of the image-side surface of the fourth lens element E4 is R8, a curvature radius of the object-side surface of the fifth lens element E5 is R9, a curvature radius of the image-side surface of the fifth lens element E5 is R10, the curvature radius of the object-side surface of the sixth lens element E6 is R11, and a curvature radius of the image-side surface of the sixth lens element E6 is R12, the following conditions are satisfied: R11/R10=0.52; |R12/R11|=1.38; R6/R8=−0.74; R8/R9=1.18; and (R11+R12)/(R11−R12)=−6.33.

In the optical lens system according to the 1st embodiment, when the central thickness of the first lens element E1 is CT1, a central thickness of the sixth lens element E6 is CT6, an axial distance between the first lens element E1 and the second lens element E2 is T12, and an axial distance between the object-side surface of the first lens element E1 to the image-side surface of the sixth lens element E6 is TD, the following conditions are satisfied: (CT1+T12)/TD=0.33; and TD/CT6=14.95.

In the optical lens system according to the 1st embodiment, when a central thickness of the second lens element E2 is CT2, and a central thickness of the fourth lens element E4 is CT4, the following condition is satisfied: CT2/CT4=1.18.

In the optical lens system according to the 1st embodiment, when an axial distance between the second lens element E2 and the third lens element E3 is T23, an axial distance between the fourth lens element E4 and the fifth lens element E5 is T45, and an axial distance between the fifth lens element E5 and the sixth lens element E6 is T56, the following conditions are satisfied: T56/T45=1.03; and T45/T23=0.09.

In the optical lens system according to the 1st embodiment, when an Abbe number of the first lens element E1 is V1, an Abbe number of the second lens element E2 is V2, an Abbe number of the third lens element E3 is V3, an Abbe number of the fourth lens element E4 is V4, an Abbe number of the fifth lens element E5 is V5, an Abbe number of the sixth lens element E6 is V6, and a minimum among V1, V2, V3, V4, V5, V6 is Vmin, the following conditions are satisfied: Vmin=19.5; and V2/V3=1.00.

FIG. 8A is a schematic view of part of parameters of the 1st embodiment. In FIG. 8A, in the optical lens system according to the 1st embodiment, when a distance in parallel with an optical axis between a maximum effective radius position of an optically effective area of the object-side surface of the fourth lens element E4 to a maximum effective radius position of an optically effective area of the image-side surface of the fourth lens element E4 is ET4, and the central thickness of the fourth lens element E4 is CT4 (not shown), the following condition is satisfied: ET4/CT4=1.39.

In the optical lens system according to the 1st embodiment, when a distance in parallel with the optical axis between a maximum effective radius position of an optically effective area of the object-side surface of the first lens element E1 to a maximum effective radius position of an optically effective area of the image-side surface of the first lens element E1 is ET1 (shown in FIG. 8A), and a distance in parallel with the optical axis between a maximum effective radius position of an optically effective area of the object-side surface of the fifth lens element E5 to a maximum effective radius position of an optically effective area of the image-side surface of the fifth lens element E5 is ET5 (shown in FIG. 8A), the following condition is satisfied: ET1/ET5=2.60.

In the optical lens system according to the 1st embodiment, when a distance in parallel with the optical axis from an axial vertex on the object-side surface of the first lens element E1 to a maximum effective radius position on the object-side surface of the first lens element E1 is SAG1R1 (shown in FIG. 8A), and a distance in parallel with the optical axis from an axial vertex on the image-side surface of the first lens element E1 to a maximum effective radius position on the image-side surface of the first lens element E1 is SAG1R2 (shown in FIG. 8A), the following condition is satisfied: SAG1R2/SAG1R1=1.81. If the displacement in parallel with the optical axis is from the object side to the image side, the value of distance in parallel with the optical axis (SAG) is positive. If the displacement is from the image side to the object side, the value of distance in parallel with the optical axis is negative.

In the optical lens system according to the 1st embodiment, when a maximum effective radius of the object-side surface of the first lens element E1 is Y1R1 (shown in FIG. 8A), and a maximum effective radius of the object-side surface of the second lens element E2 is Y2R1 (shown in FIG. 8A), the following condition is satisfied: Y1R1/Y2R1=2.95.

In the optical lens system according to the 1st embodiment, when the maximum image height of the optical lens system is ImgH, and a maximum effective radius of the image-side surface of the sixth lens element E6 is Y6R2 (shown in FIG. 8A), the following condition is satisfied: ImgH/Y6R2=1.59.

The detailed optical data of the 1st embodiment are shown in Table 1A and the aspheric surface data are shown in Table 1B below.

TABLE 1A
1st Embodiment
f = 0.45 mm, Fno = 1.80, HFOV = 78.8 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | −1.3291 | ASP | 0.276 | Plastic | 1.545 | 56.1 | −1.18 |
| 2 | | 1.3409 | ASP | 0.817 | | | | |
| 3 | Lens 2 | −1.9829 | ASP | 0.259 | Plastic | 1.544 | 56.0 | −1.60 |
| 4 | | 1.6184 | ASP | 0.242 | | | | |
| 5 | Ape. Stop | Plano | | 0.074 | | | | |
| 6 | Lens 3 | 1.3825 | ASP | 0.480 | Plastic | 1.544 | 56.0 | 0.76 |
| 7 | | −0.5206 | ASP | −0.134 | | | | |
| 8 | Stop | Plano | | 0.164 | | | | |
| 9 | Lens 4 | −100.0000 | ASP | 0.220 | Plastic | 1.669 | 19.5 | −1.04 |
| 10 | | 0.6993 | ASP | 0.030 | | | | |
| 11 | Lens 5 | 0.5945 | ASP | 0.609 | Plastic | 1.544 | 56.0 | 0.81 |
| 12 | | −1.1047 | ASP | 0.031 | | | | |
| 13 | Lens 6 | −0.5796 | ASP | 0.220 | Plastic | 1.669 | 19.5 | −5.34 |
| 14 | | −0.7972 | ASP | 0.020 | | | | |

| | | | | | | | |
|---|---|---|---|---|---|---|---|
| 15 | Stop | Plano | 0.200 | | | | |
| 16 | Filter | Plano | 0.210 | Glass | 1.517 | 64.2 | — |
| 17 | | Plano | 0.389 | | | | |
| 18 | Image | Plano | — | | | | |

Reference wavelength is 587.6 nm (d-line).
Effective radius of Surface 8 (Stop S1) is 0.425 mm.
Effective radius of Surface 15 (Stop S2) is 0.650 mm.

TABLE 1B
Aspheric Coefficients

| Surface # | 1 | 2 | 3 | 4 | 6 |
|---|---|---|---|---|---|
| k= | −1.0000000E+00 | −1.0000000E+00 | 0.0000000E+00 | −7.6312400E−01 | −2.8621200E+00 |
| A4= | 1.3358877E+00 | 8.4567726E−01 | 1.2721951E+00 | −3.4869369E−01 | −2.6559537E+00 |
| A6= | −2.3614296E+00 | 6.0009591E+00 | −1.5701093E+01 | 1.5528656E+02 | 1.8065090E+02 |
| A8= | 2.7284195E+00 | −4.6487079E+01 | 2.0052692E+02 | −4.7777656E+03 | −5.7565625E+03 |
| A10= | −2.1604691E+00 | 2.9821068E+02 | −1.6332008E+03 | 8.5477366E+04 | 1.0839212E+05 |
| A12= | 1.2074387E+00 | −1.6919093E+03 | 8.4247546E+03 | −8.5645408E+05 | −1.2686127E+06 |
| A14= | −4.7996392E−01 | 5.4835414E+03 | −2.8332570E+04 | 4.4607482E+06 | 9.2328193E+06 |
| A16= | 1.3441675E−01 | −5.3517161E+03 | 6.2286054E+04 | −8.3050771E+06 | −4.0398055E+07 |
| A18= | −2.5772534E−02 | −2.3464728E+04 | −8.6422117E+04 | −1.4585400E+07 | 9.6515494E+07 |
| A20= | 3.1885128E−03 | 9.9998042E+04 | 6.8650947E+04 | 5.4803164E+07 | −9.5825754E+07 |
| A22= | −2.2455088E−04 | −1.7862921E+05 | −2.3770470E+04 | | |
| A24= | 6.4649109E−06 | 1.7470398E+05 | | | |
| A26= | −2.5871100E−08 | −9.1295242E+04 | | | |
| A28= | 8.4880273E−09 | 1.9992721E+04 | | | |
| Surface # | 7 | 9 | 10 | 11 | 12 |
| k= | 0.0000000E+00 | 0.0000000E+00 | −1.0000000E+00 | −1.0000000E+00 | 1.1485000E+00 |
| A4= | 6.5597158E+00 | 2.3352878E+00 | −1.3166167E+01 | −1.1815801E+01 | −1.8799113E+01 |
| A6= | −4.6148303E+01 | 6.1240905E+01 | 3.5739522E+02 | 1.7637338E+02 | 2.5417501E+02 |
| A8= | −8.9950561E+02 | −2.6821423E+03 | −5.9091504E+03 | −7.0767733E+02 | 1.8884746E+03 |
| A10= | 2.7013286E+04 | 4.0175733E+04 | 5.9737789E+04 | −2.1583588E+04 | −1.0612849E+05 |
| A12= | −3.4928535E+05 | −3.4183202E+05 | −3.8674784E+05 | 4.1965511E+05 | 1.5899214E+06 |
| A14= | 2.8145096E+06 | 1.7861919E+06 | 1.6317237E+06 | −3.7041482E+06 | −1.3527338E+07 |
| A16= | −1.4912934E+07 | −5.7056160E+06 | −4.4167629E+06 | 1.9517420E+07 | 7.4300650E+07 |
| A18= | 5.0465435E+07 | 1.0290575E+07 | 7.1105282E+06 | −6.4861573E+07 | −2.7347081E+08 |
| A20= | −9.8562166E+07 | −8.0547470E+06 | −5.0922440E+06 | 1.3379021E+08 | 6.7251217E+08 |
| A22= | 8.4234799E+07 | | −1.7262359E+06 | −1.5686886E+08 | −1.0624014E+09 |
| A24= | | | 3.9743213E+06 | 8.0015181E+07 | 9.7602494E+08 |
| A26= | | | | | −3.9660943E+08 |

| Surface # | 13 | 14 |
|---|---|---|
| k= | −1.0000000E+00 | −1.0000000E+00 |
| A4= | −1.7676984E+01 | 7.3839851E−01 |
| A6= | 4.2436389E+02 | 3.3406968E+01 |
| A8= | −2.7057169E+03 | 1.7358529E+02 |
| A10= | −3.7845995E+04 | −1.1053119E+04 |
| A12= | 9.1660996E+05 | 1.4491427E+05 |
| A14= | −8.8911829E+06 | −1.0552679E+06 |
| A16= | 5.1679911E+07 | 4.9500828E+06 |
| A18= | −1.9568567E+08 | −1.5606948E+07 |
| A20= | 4.8843609E+08 | 3.3023929E+07 |
| A22= | −7.7742602E+08 | −4.5100267E+07 |
| A24= | 7.1646827E+08 | 3.5984867E+07 |
| A26= | −2.9126255E+08 | −1.2756996E+07 |

Table 1A shows the detailed optical data of FIG. 1A of the 1st embodiment, wherein the curvature radius, thickness and the focal length are shown in millimeters (mm), surface numbers 0-18 represent the surfaces sequentially arranged from the object side to the image side, and the refractive index is measured in accordance with the reference wavelength. Table 1B shows the aspheric surface data of the 1st embodiment, wherein k represents the conic coefficient of the equation of the aspheric surface profiles, and A4-A28 represent the aspheric coefficients of each surface ranging from the 4th order to the 28th order. The tables presented below for each embodiment correspond to the schematic view and aberration curves of each embodiment, and term definitions of the tables are the same as those in Table 1A and Table 1B of the 1st embodiment. Therefore, an explanation in this regard will not be provided again.

### 2nd Embodiment

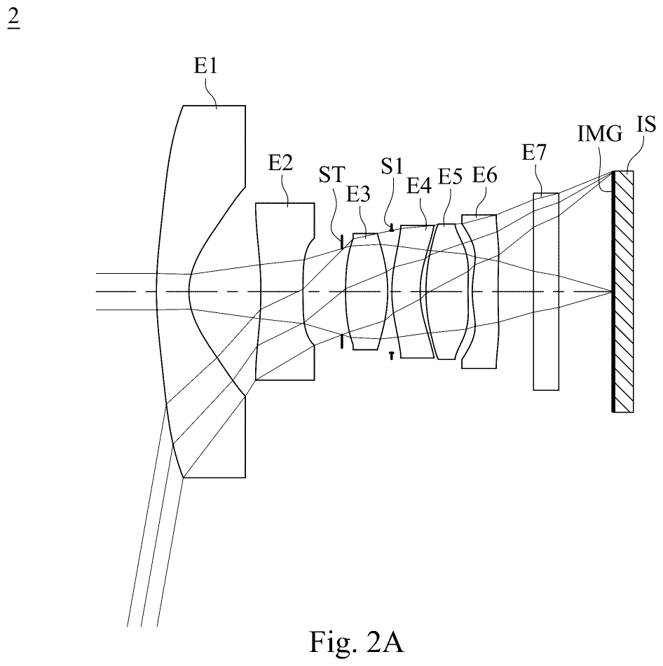

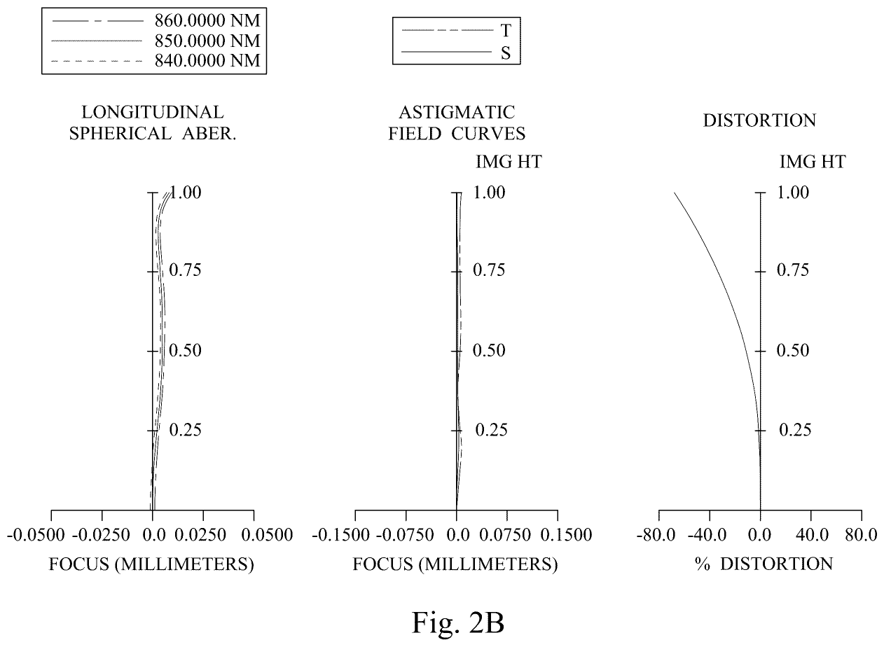

FIG. 2A is a schematic view of an imaging apparatus 2 according to the 2nd embodiment of the present disclosure. FIG. 2B shows, in order from left to right, spherical aberration curves, astigmatic field curves and a distortion curve of the imaging apparatus 2 according to the 2nd embodiment. In FIG. 2A, the imaging apparatus 2 according to the 2nd embodiment includes an optical lens system (its reference number is omitted) and an image sensor IS. The optical lens system includes, in order from an object side to an image side along an optical path, a first lens element E1, a second lens element E2, an aperture stop ST, a third lens element E3, a stop S1, a fourth lens element E4, a fifth lens element E5, a sixth lens element E6, a filter E7 and an image surface IMG, wherein the image sensor IS is disposed on the image surface IMG of the optical lens system. The optical lens system includes six lens elements (E1, E2, E3, E4, E5, E6) without additional one or more lens elements inserted between the first lens element E1 and the sixth lens element E6.

The first lens element E1 with negative refractive power has an object-side surface being convex in a paraxial region thereof and an image-side surface being concave in a paraxial region thereof. The first lens element E1 is made of plastic material, and has the object-side surface and the image-side surface being both aspheric. Moreover, the object-side surface of the first lens element E1 includes two inflection points, the image-side surface of the first lens element E1 includes two inflection points.

The second lens element E2 with negative refractive power has an object-side surface being concave in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes one inflection point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the image-side surface of the third lens element E3 includes one inflection point.

The fourth lens element E4 with negative refractive power has an object-side surface being convex in a paraxial region thereof and an image-side surface being concave in a paraxial region thereof. The fourth lens element E4 is surface being both aspheric. Moreover, the object-side surface of the fourth lens element E4 includes one inflection point, the image-side surface of the fourth lens element E4 includes one inflection point.

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric. Moreover, the image-side surface of the fifth lens element E5 includes two inflection points and two critical points.

The sixth lens element E6 with positive refractive power has an object-side surface being convex in a paraxial region thereof and an image-side surface being concave in a paraxial region thereof. The sixth lens element E6 is made of plastic material, and has the object-side surface and the image-side surface being both aspheric. Moreover, the object-side surface of the sixth lens element E6 includes one inflection point and one critical point, the image-side surface of the sixth lens element E6 includes three inflection points and one critical point.

The filter E7 is made of glass material and disposed between the sixth lens element E6 and the image surface IMG and will not affect a focal length of the optical lens system.

The detailed optical data of the 2nd embodiment are shown in Table 2A and the aspheric surface data are shown in Table 2B below.

TABLE 2A
2nd Embodiment
f = 0.54 mm, Fno = 1.80, HFOV = 80.0 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 2.8921 | ASP | 0.270 | Plastic | 1.645 | 19.5 | −1.10 |
| 2 | | 0.5486 | ASP | 0.597 | | | | |
| 3 | Lens 2 | −3.1988 | ASP | 0.350 | Plastic | 1.645 | 19.5 | −3.57 |
| 4 | | 8.5837 | ASP | 0.324 | | | | |
| 5 | Ape. Stop | Plano | | 0.030 | | | | |
| 6 | Lens 3 | 2.3938 | ASP | 0.350 | Plastic | 1.645 | 19.5 | 1.28 |
| 7 | | −1.1947 | ASP | 0.032 | | | | |
| 8 | Stop | Plano | | 0.003 | | | | |
| 9 | Lens 4 | 1.1866 | ASP | 0.235 | Plastic | 1.645 | 19.5 | −6.80 |
| 10 | | 0.8613 | ASP | 0.048 | | | | |
| 11 | Lens 5 | 1.7033 | ASP | 0.349 | Plastic | 1.527 | 56.0 | 13.34 |
| 12 | | 2.0889 | ASP | 0.035 | | | | |
| 13 | Lens 6 | 0.8099 | ASP | 0.215 | Plastic | 1.645 | 19.5 | 1.34 |
| 14 | | 11.8162 | ASP | 0.295 | | | | |

| | | | | | | | |
|---|---|---|---|---|---|---|---|
| 15 | Filter | Plano | 0.210 | Glass | 1.510 | 64.2 | — |
| 16 | | Plano | 0.453 | | | | |
| 17 | Image | Plano | — | | | | |

Reference wavelength is 850.0 nm.
Effective radius of Surface 8 (Stop S1) is 0.509 mm.

TABLE 2B
Aspheric Coefficients

| Surface # | 1 | 2 | 3 | 4 | 6 |
|---|---|---|---|---|---|
| k= | 3.2596900E−01 | −1.0000000E+00 | 0.0000000E+00 | 9.0000000E+01 | 1.3951300E+00 |
| A4= | −1.9103560E−01 | −3.2019583E−01 | 7.8262178E−02 | 1.2834747E+00 | 5.9450767E−01 |
| A6= | 1.6337594E−01 | −6.8339499E−01 | −4.9285490E−01 | 2.1111307E+00 | −3.0334966E−01 |
| A8= | −8.9583047E−02 | 1.3769880E+00 | 5.5348839E+00 | 2.1549102E+00 | 1.1861172E+00 |
| A10= | 3.7486085E−02 | −4.7375593E+00 | −1.8504888E+01 | 6.4041263E+01 | 1.8157024E−01 |
| A12= | −1.2787722E−02 | 1.6235002E+01 | 3.0541697E+01 | −1.4174824E+02 | |
| A14= | 3.3463388E−03 | −2.6747881E+01 | −2.5786014E+01 | | |
| A16= | −5.5581458E−04 | 2.0748762E+01 | 8.8467391E+00 | | |
| A18= | 4.1291118E−05 | −6.0807148E+00 | | | |
| Surface # | 7 | 9 | 10 | 11 | 12 |
| k= | 2.9411700E+00 | 4.3308600E−01 | 1.1973800E−02 | −3.9773500E+01 | 6.8677600E+00 |
| A4= | 4.2077741E−01 | −5.9297825E−01 | −5.6121373E−01 | 1.5490976E+00 | −5.5577715E+00 |
| A6= | −6.6972478E−02 | −7.7450306E−01 | −1.8078456E+00 | −7.0349157E+00 | 1.7276529E+01 |
| A8= | 5.5994857E+00 | 6.2549458E+00 | 1.5398766E+00 | 1.9158269E+01 | −1.2947235E+01 |
| A10= | −1.7762767E+01 | −2.6296511E+01 | 5.6628989E−01 | −8.8124663E+01 | −1.2595718E+02 |
| A12= | 6.1792147E+01 | 3.3465053E+01 | 3.8521789E+00 | 3.2281113E+02 | 5.0028485E+02 |
| A14= | | | | −3.8759575E+02 | −5.1096902E+02 |

| Surface # | 13 | 14 |
|---|---|---|
| k= | −1.1123100E+01 | 0.0000000E+00 |
| A4= | −1.6740271E+00 | 1.2718387E+00 |
| A6= | −1.5306126E+01 | −1.8997519E+01 |
| A8= | 1.1281676E+02 | 9.1321498E+01 |
| A10= | −6.5525335E+02 | −2.4921752E+02 |
| A12= | 3.3494518E+03 | 5.1081555E+02 |
| A14= | −1.0057116E+04 | −8.1526316E+02 |
| A16= | 1.5164214E+04 | 7.9688884E+02 |
| A18= | −9.1210830E+03 | −3.2482506E+02 |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
2nd Embodiment

| | | | |
|---|---|---|---|
| f [mm] | 0.54 | R6/R8 | −1.39 |
| Fno | 1.80 | R8/R9 | 0.51 |
| HFOV [deg.] | 80.0 | (R11 + R12)/(R11 − R12) | −1.15 |
| FOV [deg.] | 160.0 | (CT1 + T12)/TD | 0.31 |
| TL/ImgH | 3.81 | TD/CT6 | 13.20 |
| f/tan(HFOV) [mm] | 0.10 | CT2/CT4 | 1.49 |
| TL/f | 7.00 | T56/T45 | 0.73 |
| f1/BL | −1.15 | T45/T23 | 0.14 |
| f/CT1 | 2.01 | Vmin | 19.5 |
| f1/TL | −0.29 | V2/V3 | 1.00 |
| f12/BL | −0.78 | ET4/CT4 | 1.18 |
| \|R11\|/f12 | −1.09 | ET1/ET5 | 3.68 |
| f1/CT1 | −4.07 | SAG1R2/SAG1R1 | 2.11 |
| R11/R10 | 0.39 | Y1R1/Y2R1 | 2.10 |
| \|R12/R11\| | 14.59 | ImgH/Y6R2 | 1.57 |

### 3rd Embodiment

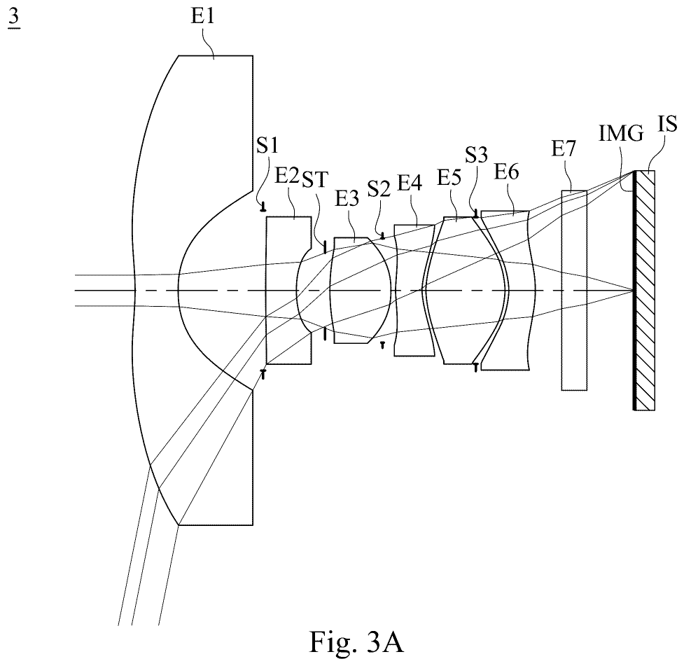

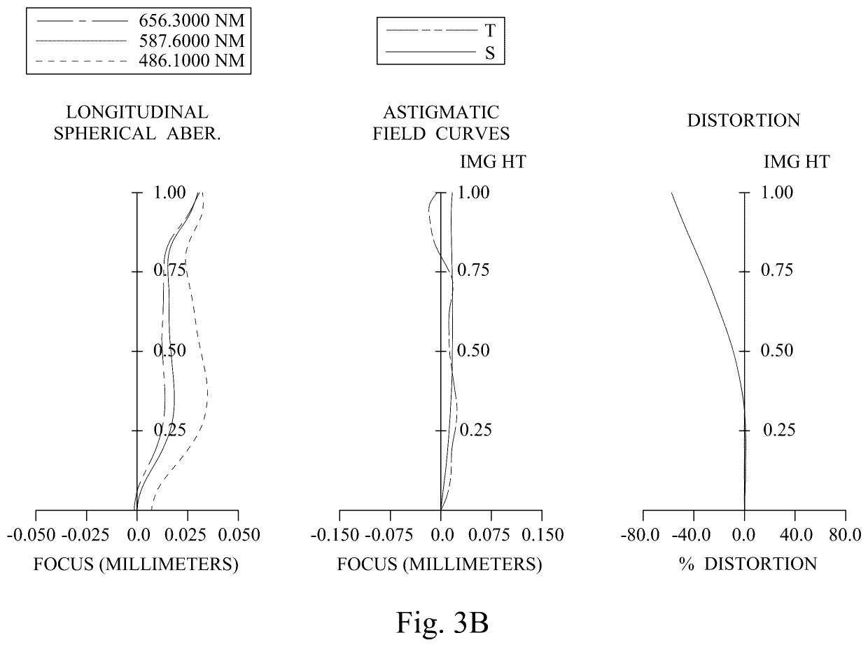

FIG. 3A is a schematic view of an imaging apparatus 3 according to the 3rd embodiment of the present disclosure. FIG. 3B shows, in order from left to right, spherical aberration curves, astigmatic field curves and a distortion curve of the imaging apparatus 3 according to the 3rd embodiment. In FIG. 3A, the imaging apparatus 3 according to the 3rd embodiment includes an optical lens system (its reference number is omitted) and an image sensor IS. The optical lens system includes, in order from an object side to an image side along an optical path, a first lens element E1, a stop S1, a second lens element E2, an aperture stop ST, a third lens element E3, a stop S2, a fourth lens element E4, a fifth lens element E5, a stop S3, a sixth lens element E6, a filter E7 and an image surface IMG, wherein the image sensor IS is disposed on the image surface IMG of the optical lens system. The optical lens system includes six lens elements (E1, E2, E3, E4, E5, E6) without additional one or more lens elements inserted between the first lens element E1 and the sixth lens element E6.

The first lens element E1 with negative refractive power has an object-side surface being concave in a paraxial region thereof and an image-side surface being concave in a paraxial region thereof. The first lens element E1 is made of plastic material, and has the object-side surface and the image-side surface being both aspheric. Moreover, the object-side surface of the first lens element E1 includes one inflection point and one critical point, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes two inflection points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes one inflection point.

The fourth lens element E4 with negative refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes one inflection point and one critical point, the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Moreover, the object-side surface of the fifth lens element E5 includes two inflection points, the image-side surface of the fifth lens element E5 includes one inflection point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Moreover, the object-side surface of the sixth lens element E6 includes three inflection points, the image-side surface of the sixth lens element E6 includes one inflection point and one critical point.

The filter E7 is made of glass material and disposed between the sixth lens element E6 and the image surface IMG and will not affect a focal length of the optical lens system.

The detailed optical data of the 3rd embodiment are shown in Table 3A and the aspheric surface data are shown in Table 3B below.

TABLE 3A
3rd Embodiment
f = 0.47 mm, Fno = 1.82, HFOV = 78.7 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | −2.0769 | ASP | 0.358 | Plastic | 1.545 | 56.1 | −1.14 |
| 2 | | 0.9418 | ASP | 0.707 | | | | |
| 3 | Stop | Plano | | 0.021 | | | | |
| 4 | Lens 2 | 21.3205 | ASP | 0.255 | Plastic | 1.544 | 56.0 | −1.63 |
| 5 | | 0.8467 | ASP | 0.239 | | | | |
| 6 | Ape. Stop | Plano | | 0.040 | | | | |
| 7 | Lens 3 | 1.6496 | ASP | 0.507 | Plastic | 1.544 | 56.0 | 1.29 |
| 8 | | −1.0850 | ASP | −0.069 | | | | |
| 9 | Stop | Plano | | 0.108 | | | | |
| 10 | Lens 4 | 0.6983 | ASP | 0.220 | Plastic | 1.669 | 19.5 | −2.16 |
| 11 | | 0.4111 | ASP | 0.032 | | | | |
| 12 | Lens 5 | 0.5194 | ASP | 0.658 | Plastic | 1.544 | 56.0 | 0.60 |
| 13 | | −0.4880 | ASP | −0.243 | | | | |
| 14 | Stop | Plano | | 0.275 | | | | |
| 15 | Lens 6 | −0.4415 | ASP | 0.220 | Plastic | 1.669 | 19.5 | −1.68 |
| 16 | | −0.8726 | ASP | 0.220 | | | | |

| | | | | | | | |
|---|---|---|---|---|---|---|---|
| 17 | Filter | Plano | 0.210 | Glass | 1.517 | 64.2 | — |
| 18 | | Plano | 0.396 | | | | |
| 19 | Image | Plano | — | | | | |

Reference wavelength is 587.6 nm (d-line).
Effective radius of Surface 3 (Stop S1) is 0.665 mm.
Effective radius of Surface 9 (Stop S2) is 0.433 mm.
Effective radius of Surface 14 (Stop S3) is 0.610 mm.

TABLE 3B
Aspheric Coefficients

| Surface # | 1 | 2 | 4 | 5 | 7 |
|---|---|---|---|---|---|
| k= | −1.0000000E+00 | −1.0000000E+00 | 0.0000000E+00 | 0.0000000E+00 | 0.0000000E+00 |
| A4= | 8.7664997E−01 | 8.0084046E−01 | 2.8018244E−01 | −9.6519739E−01 | −6.1637770E−01 |
| A6= | −1.6123064E+00 | 2.0473386E+00 | −7.1581469E+00 | 4.4683991E+02 | 5.8054457E+01 |
| A8= | 2.0687543E+00 | 5.4078349E+00 | 1.1494111E+02 | −3.9868292E+04 | −2.5873386E+03 |
| A10= | −1.8803552E+00 | −2.1817260E+02 | −1.1274635E+03 | 2.1550538E+06 | 6.3786223E+04 |
| A12= | 1.2341304E+00 | 1.3964120E+03 | 6.8076707E+03 | −7.4924700E+07 | −9.2186138E+05 |
| A14= | −5.9084998E−01 | −4.6984856E+03 | −2.6133974E+04 | 1.7519148E+09 | 7.5906948E+06 |
| A16= | 2.0638273E−01 | 9.8054227E+03 | 6.4231206E+04 | −2.8239786E+10 | −2.9967740E+07 |
| A18= | −5.1998716E−02 | −1.3243002E+04 | −9.8119569E+04 | 3.1766412E+11 | −1.4685842E+06 |
| A20= | 9.1976292E−03 | 1.1353716E+04 | 8.5058705E+04 | −2.5071221E+12 | 4.1784020E+08 |
| A22= | −1.0831395E−03 | −5.6354443E+03 | −3.2077312E+04 | 1.3991414E+13 | −9.9718332E+08 |
| A24= | 7.6225265E−05 | 1.2315510E+03 | | −5.6621797E+13 | |
| A26= | −2.4244309E−06 | | | 1.7346465E+14 | |
| A28= | | | | −3.9085464E+14 | |
| A30= | | | | 4.7352197E+14 | |
| Surface # | 8 | 10 | 11 | 12 | 13 |
| k= | −1.0000000E+00 | 0.0000000E+00 | −1.0000000E+00 | −1.0000000E+00 | −1.0000000E+00 |
| A4= | −1.8774492E+01 | −2.0840292E+01 | −1.7063367E+01 | −1.0601553E+01 | 1.3376226E+01 |
| A6= | 5.0239316E+02 | 4.6118793E+02 | 3.0734873E+02 | 1.7531824E+02 | −3.1074174E+02 |
| A8= | −1.0261511E+04 | −8.3789114E+03 | −5.1993568E+03 | −2.7848962E+03 | 4.3615720E+03 |
| A10= | 1.5666054E+05 | 1.1550789E+05 | 7.4464268E+04 | 3.8123409E+04 | −4.7305914E+04 |
| A12= | −1.7551507E+06 | −1.1652859E+06 | −8.0374939E+05 | −3.8435604E+05 | 4.1282670E+05 |
| A14= | 1.4081965E+07 | 8.2695788E+06 | 6.2079124E+06 | 2.7091797E+06 | −2.7157935E+06 |
| A16= | −7.8873181E+07 | −3.9702522E+07 | −3.3899833E+07 | −1.3300549E+07 | 1.2774599E+07 |
| A18= | 2.9797319E+08 | 1.2204493E+08 | 1.2989767E+08 | 4.5388003E+07 | −4.1774013E+07 |
| A20= | −7.1658556E+08 | −2.1612342E+08 | −3.4221318E+08 | −1.0579569E+08 | 9.2475661E+07 |
| A22= | 9.7879921E+08 | 1.6736034E+08 | 5.9122018E+08 | 1.6091383E+08 | −1.3217214E+08 |
| A24= | −5.6815503E+08 | | −6.0375414E+08 | −1.4407212E+08 | 1.1016375E+08 |
| A26= | | | 2.7638670E+08 | 5.7611252E+07 | −4.0713038E+07 |

| Surface # | 15 | 16 |
|---|---|---|
| k= | −1.0000000E+00 | 0.0000000E+00 |
| A4= | 1.4995810E+01 | 3.6185306E+00 |
| A6= | −3.2019761E+02 | −3.6809733E+01 |
| A8= | 4.4904375E+03 | 4.1733669E+02 |
| A10= | −5.0537578E+04 | −4.2995524E+03 |
| A12= | 4.6696304E+05 | 3.6030480E+04 |
| A14= | −3.2442168E+06 | −2.1574668E+05 |
| A16= | 1.5949190E+07 | 8.8302983E+05 |
| A18= | −5.3965288E+07 | −2.4413312E+06 |
| A20= | 1.2258749E+08 | 4.4835509E+06 |
| A22= | −1.7855573E+08 | −5.2432760E+06 |
| A24= | 1.5077828E+08 | 3.5361610E+06 |
| A26= | −5.6175344E+07 | −1.0474708E+06 |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
3rd Embodiment

| | | | |
|---|---|---|---|
| f [mm] | 0.47 | R6/R8 | −2.64 |
| Fno | 1.82 | R8/R9 | 0.79 |
| HFOV [deg.] | 78.7 | (R11 + R12)/(R11 − R12) | −3.05 |
| FOV [deg.] | 157.4 | (CT1 + T12)/TD | 0.33 |
| TL/ImgH | 4.17 | TD/CT6 | 15.13 |
| f/tan(HFOV) [mm] | 0.09 | CT2/CT4 | 1.16 |
| TL/f | 8.91 | T56/T45 | 1.00 |
| f1/BL | −1.38 | T45/T23 | 0.11 |
| f/CT1 | 1.30 | Vmin | 19.5 |
| f1/TL | −0.27 | V2/V3 | 1.00 |
| f12/BL | −0.60 | ET4/CT4 | 1.53 |
| \|R11\|/f12 | −0.89 | ET1/ET5 | 2.65 |
| f1/CT1 | −3.18 | SAG1R2/SAG1R1 | 1.71 |
| R11/R10 | 0.90 | Y1R1/Y2R1 | 3.19 |
| \|R12/R11\| | 1.98 | ImgH/Y6R2 | 1.51 |

### 4th Embodiment

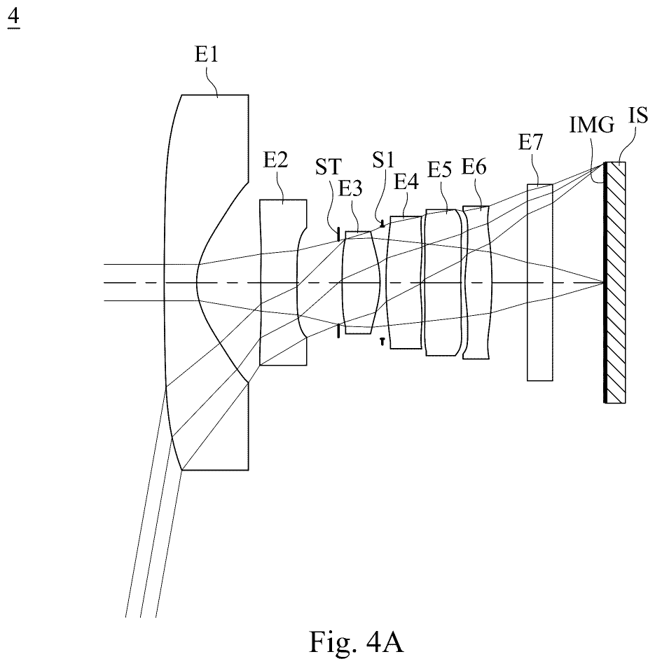

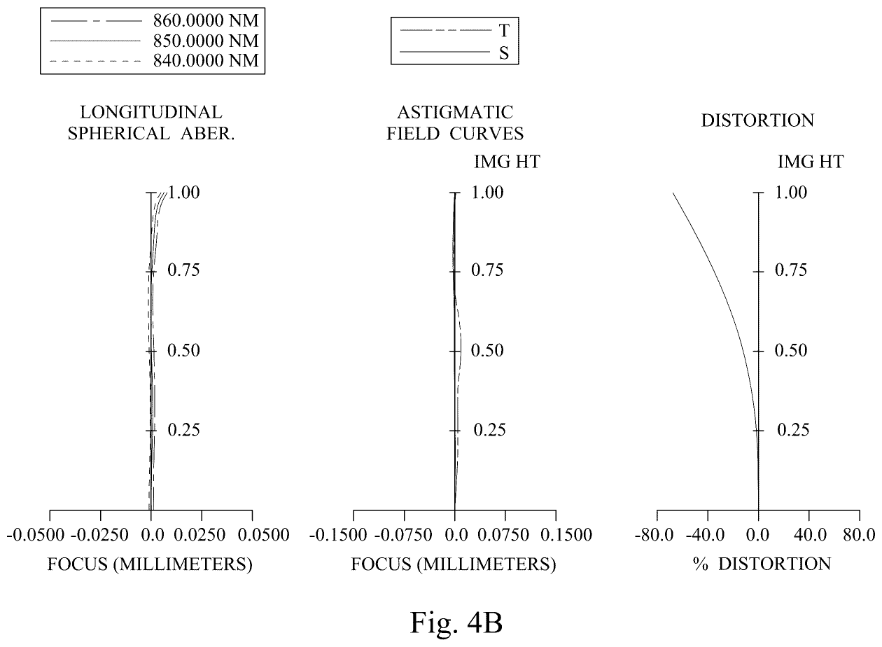

FIG. 4A is a schematic view of an imaging apparatus 4 according to the 4th embodiment of the present disclosure. FIG. 4B shows, in order from left to right, spherical aberration curves, astigmatic field curves and a distortion curve of the imaging apparatus 4 according to the 4th embodiment. In FIG. 4A, the imaging apparatus 4 according to the 4th embodiment includes an optical lens system (its reference number is omitted) and an image sensor IS. The optical lens system includes, in order from an object side to an image side along an optical path, a first lens element E1, a second lens element E2, an aperture stop ST, a third lens element E3, a stop S1, a fourth lens element E4, a fifth lens element E5, a sixth lens element E6, a filter E7 and an image surface IMG, wherein the image sensor IS is disposed on the image surface IMG of the optical lens system. The optical lens system includes six lens elements (E1, E2, E3, E4, E5, E6) without additional one or more lens elements inserted between the first lens element E1 and the sixth lens element E6.

The first lens element E1 with negative refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with positive refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes two inflection points and two critical points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the image-side surface of the third lens element E3 includes one inflection point.

The fourth lens element E4 with negative refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes one inflection point, the image-side surface of the fourth lens element E4 includes two inflection points and two critical points.

The fifth lens element E5 with negative refractive power has an object-side surface being convex in a paraxial region thereof and an image-side surface being concave in a paraxial region thereof. The fifth lens element E5 is made of plastic material, and has the object-side surface and the image-side surface being both aspheric. Moreover, the object-side surface of the fifth lens element E5 includes two inflection points and two critical points, the image-side surface of the fifth lens element E5 includes four inflection points and three critical points.

The sixth lens element E6 with positive refractive power has an object-side surface being convex in a paraxial region thereof and an image-side surface being convex in a paraxial region thereof. The sixth lens element E6 is made of plastic material, and has the object-side surface and the image-side surface being both aspheric. Moreover, the object-side surface of the sixth lens element E6 includes one inflection point and one critical point, the image-side surface of the sixth lens element E6 includes two inflection points and one critical point.

The filter E7 is made of glass material and disposed between the sixth lens element E6 and the image surface IMG and will not affect a focal length of the optical lens system.

The detailed optical data of the 4th embodiment are shown in Table 4A and the aspheric surface data are shown in Table 4B below.

TABLE 4A
4th Embodiment
f = 0.54 mm, Fno = 1.80, HFOV = 80.0 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 16.5921 | ASP | 0.270 | Plastic | 1.645 | 19.5 | −0.90 |
| 2 | | 0.5592 | ASP | 0.533 | | | | |
| 3 | Lens 2 | 5.8289 | ASP | 0.300 | Plastic | 1.645 | 19.5 | 34.01 |
| 4 | | 7.7779 | ASP | 0.346 | | | | |
| 5 | Ape. Stop | Plano | | 0.030 | | | | |
| 6 | Lens 3 | 5.9727 | ASP | 0.315 | Plastic | 1.645 | 19.5 | 1.07 |
| 7 | | −0.7609 | ASP | 0.020 | | | | |
| 8 | Stop | Plano | | 0.030 | | | | |
| 9 | Lens 4 | 3.6738 | ASP | 0.286 | Plastic | 1.645 | 19.5 | −4.00 |
| 10 | | 1.4701 | ASP | 0.035 | | | | |
| 11 | Lens 5 | 5.3375 | ASP | 0.300 | Plastic | 1.645 | 19.5 | −5.31 |
| 12 | | 2.0408 | ASP | 0.035 | | | | |
| 13 | Lens 6 | 0.9710 | ASP | 0.224 | Plastic | 1.645 | 19.5 | 1.17 |
| 14 | | −3.1294 | ASP | 0.295 | | | | |

| | | | | | | | |
|---|---|---|---|---|---|---|---|
| 15 | Filter | Plano | 0.210 | Glass | 1.510 | 64.2 | — |
| 16 | | Plano | 0.438 | | | | |
| 17 | Image | Plano | — | | | | |

Reference wavelength is 850.0 nm.
Effective radius of Surface 8 (Stop S1) is 0.467 mm.

TABLE 4B
Aspheric Coefficients

| Surface # | 1 | 2 | 3 | 4 | 6 |
|---|---|---|---|---|---|
| k= | 0.0000000E+00 | −1.0000000E+00 | −9.0000000E+01 | 0.0000000E+00 | −9.1726100E+00 |
| A4= | −4.8120918E−02 | −4.5389460E−01 | −6.3705179E−01 | 2.7351878E−01 | 8.0606201E−01 |
| A6= | 6.7627795E−02 | −8.3767676E−03 | −7.8875068E−01 | 6.6609539E+00 | −3.6952972E−02 |
| A8= | −3.1901576E−02 | −2.7431100E+00 | 1.7148260E+01 | −2.3786780E+01 | 7.2711209E+00 |
| A10= | 7.6994484E−03 | 1.1054145E+01 | −6.0086878E+01 | 1.5368784E+02 | 1.6303896E+01 |
| A12= | −6.8594886E−04 | −1.6030736E+01 | 1.0153266E+02 | −2.4906424E+02 | −1.0414438E+02 |
| A14= | −4.2129572E−05 | 9.9616295E+00 | −8.7941561E+01 | | |
| A16= | 7.3470431E−06 | −1.7486766E+00 | 3.1350923E+01 | | |
| Surface # | 7 | 9 | 10 | 11 | 12 |
| k= | 7.5306500E−01 | 0.0000000E+00 | −1.6237200E+01 | 5.5835400E+01 | 2.8593500E+00 |
| A4= | 2.6223013E+00 | 9.5587559E−01 | −2.1310855E+00 | −1.4492836E+00 | −5.5821775E+00 |
| A6= | −1.5476484E+01 | −1.3446730E+01 | 1.8496733E+00 | 7.8935352E+00 | 6.2847520E+01 |
| A8= | 1.1108289E+02 | 8.0770839E+01 | 2.4914029E+01 | −4.1525131E+01 | −4.4381376E+02 |
| A10= | −3.5847725E+02 | −2.1591744E+02 | −6.5554255E+01 | 3.7970717E+02 | 2.1762422E+03 |
| A12= | 5.9130116E+02 | 1.9755459E+02 | 4.8282006E+01 | −2.3655421E+03 | −6.9593597E+03 |
| A14= | | | | 7.5543066E+03 | 1.2611864E+04 |
| A16= | | | | −1.1439936E+04 | −1.1064288E+04 |
| A18= | | | | 6.4732781E+03 | 3.3196217E+03 |

| Surface # | 13 | 14 |
|---|---|---|
| k= | −3.3949600E−01 | 1.0900200E+01 |
| A4= | −5.5749685E+00 | 5.5988000E−01 |
| A6= | 4.0321806E+01 | −1.2569927E+01 |
| A8= | −2.0012961E+02 | 1.4882970E+02 |
| A10= | 3.3160258E+02 | −1.0894107E+03 |
| A12= | 2.3287246E+03 | 5.0291058E+03 |
| A14= | −1.4604015E+04 | −1.3827835E+04 |
| A16= | 3.2140208E+04 | 2.1734127E+04 |
| A18= | −3.0044689E+04 | −1.7977248E+04 |
| A20= | 9.2103257E+03 | 6.0539649E+03 |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
4th Embodiment

| | | | |
|---|---|---|---|
| f [mm] | 0.54 | R6/R8 | −0.52 |
| Fno | 1.80 | R8/R9 | 0.28 |
| HFOV [deg.] | 80.0 | (R11 + R12)/(R11 − R12) | −0.53 |
| FOV [deg.] | 160.0 | (CT1 + T12)/TD | 0.29 |
| TL/ImgH | 3.68 | TD/CT6 | 12.16 |
| f/tan(HFOV) [mm] | 0.10 | CT2/CT4 | 1.05 |
| TL/f | 6.74 | T56/T45 | 1.00 |
| f1/BL | −0.96 | T45/T23 | 0.09 |
| f/CT1 | 2.02 | Vmin | 19.5 |
| f1/TL | −0.25 | V2/V3 | 1.00 |
| f12/BL | −0.98 | ET4/CT4 | 0.91 |
| \|R11\|/f12 | −1.05 | ET1/ET5 | 2.29 |
| f1/CT1 | −3.33 | SAG1R2/SAG1R1 | 2.93 |
| R11/R10 | 0.48 | Y1R1/Y2R1 | 2.27 |
| \|R12/R11\| | 3.22 | ImgH/Y6R2 | 1.58 |

### 5th Embodiment

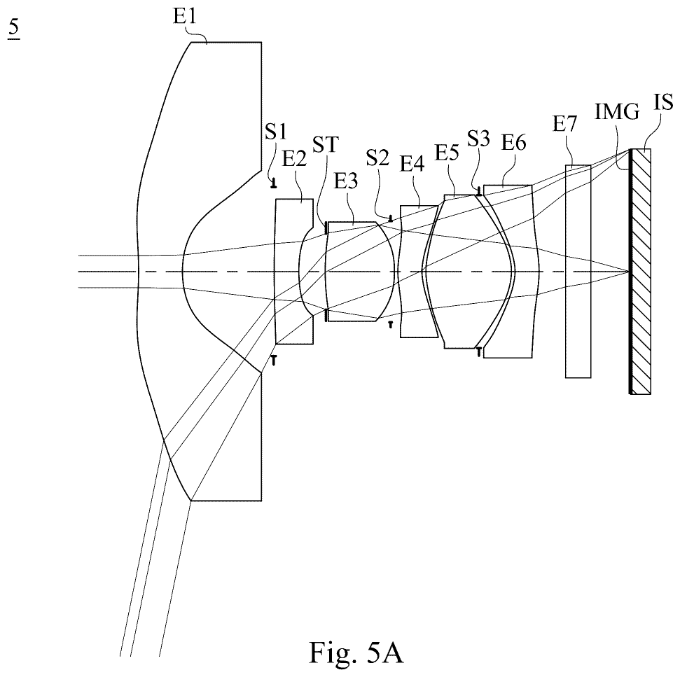

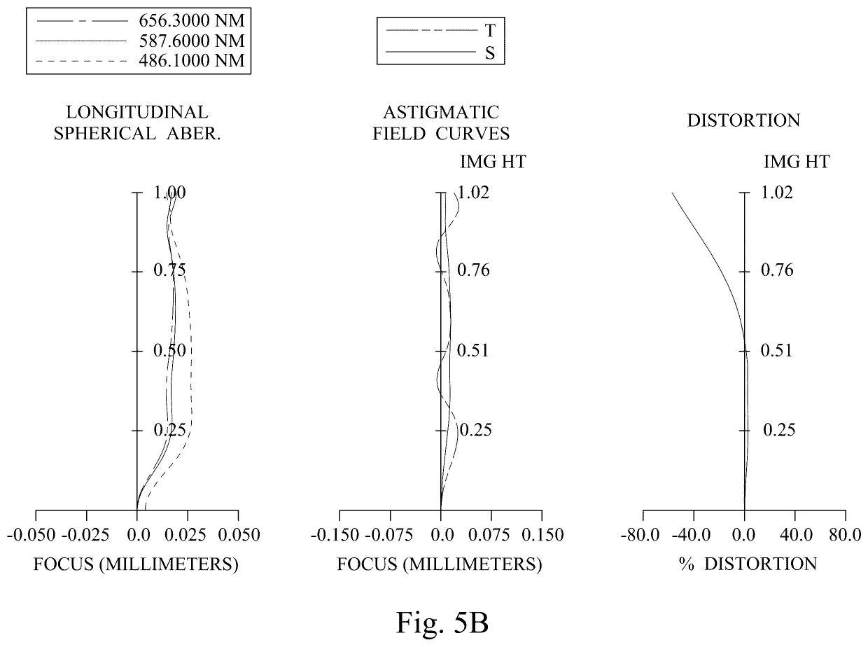

FIG. 5A is a schematic view of an imaging apparatus 5 according to the 5th embodiment of the present disclosure. FIG. 5B shows, in order from left to right, spherical aberration curves, astigmatic field curves and a distortion curve of the imaging apparatus 5 according to the 5th embodiment. In FIG. 5A, the imaging apparatus 5 according to the 5th embodiment includes an optical lens system (its reference number is omitted) and an image sensor IS. The optical lens system includes, in order from an object side to an image side along an optical path, a first lens element E1, a stop S1, a second lens element E2, an aperture stop ST, a third lens element E3, a stop S2, a fourth lens element E4, a fifth lens element E5, a stop S3, a sixth lens element E6, a filter E7 and an image surface IMG, wherein the image sensor IS is disposed on the image surface IMG of the optical lens system. The optical lens system includes six lens elements (E1, E2, E3, E4, E5, E6) without additional one or more lens elements inserted between the first lens element E1 and the sixth lens element E6.

The first lens element E1 with negative refractive power has an object-side surface being concave in a paraxial region thereof and an image-side surface being concave in a paraxial region thereof. The first lens element E1 is made of glass material, and has the object-side surface and the image-side surface being both aspheric. Moreover, the object-side surface of the first lens element E1 includes three inflection points and one critical point, the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes two inflection points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes one inflection point.

The fourth lens element E4 with negative refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes one inflection point and one critical point, the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Moreover, the image-side surface of the fifth lens element E5 includes one inflection point.

The sixth lens element E6 with negative refractive power has an object-side surface being concave in a paraxial region thereof and an image-side surface being convex in a paraxial region thereof. The sixth lens element E6 is surface being both aspheric. Moreover, the object-side surface of the sixth lens element E6 includes one inflection point, the image-side surface of the sixth lens element E6 includes three inflection points and one critical point.

The filter E7 is made of glass material and disposed between the sixth lens element E6 and the image surface IMG and will not affect a focal length of the optical lens system.

The detailed optical data of the 5th embodiment are shown in Table 5A and the aspheric surface data are shown in Table 5B below.

TABLE 5A
5th Embodiment
f = 0.49 mm, Fno = 1.82, HFOV = 78.5 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | −2.7041 | ASP | 0.364 | Glass | 1.547 | 62.7 | −1.07 |
| 2 | | 0.7855 | ASP | 0.759 | | | | |
| 3 | Stop | Plano | | 0.004 | | | | |
| 4 | Lens 2 | 125.0000 | ASP | 0.205 | Plastic | 1.544 | 56.0 | −2.48 |
| 5 | | 1.3331 | ASP | 0.225 | | | | |
| 6 | Ape. Stop | Plano | | −0.006 | | | | |
| 7 | Lens 3 | 2.1390 | ASP | 0.575 | Plastic | 1.545 | 56.1 | 1.67 |
| 8 | | −1.4382 | ASP | −0.031 | | | | |
| 9 | Stop | Plano | | 0.060 | | | | |
| 10 | Lens 4 | 0.5757 | ASP | 0.200 | Plastic | 1.614 | 25.6 | −4.12 |
| 11 | | 0.4070 | ASP | 0.033 | | | | |
| 12 | Lens 5 | 0.5337 | ASP | 0.711 | Plastic | 1.544 | 56.0 | 0.59 |
| 13 | | −0.4338 | ASP | −0.270 | | | | |
| 14 | Stop | Plano | | 0.300 | | | | |
| 15 | Lens 6 | −0.3951 | ASP | 0.200 | Plastic | 1.697 | 16.3 | −1.19 |
| 16 | | −0.9085 | ASP | 0.220 | | | | |

| | | | | | | | |
|---|---|---|---|---|---|---|---|
| 17 | Filter | Plano | 0.210 | Glass | 1.517 | 64.2 | — |
| 18 | | Plano | 0.331 | | | | |
| 19 | Image | Plano | — | | | | |

Reference wavelength is 587.6 nm (d-line).
Effective radius of Surface 3 (Stop S1) is 0.703 mm.
Effective radius of Surface 9 (Stop S2) is 0.420 mm.
Effective radius of Surface 14 (Stop S3) is 0.636 mm.

TABLE 5B
Aspheric Coefficients

| Surface # | 1 | 2 | 4 | 5 | 7 |
|---|---|---|---|---|---|
| k= | −1.1313500E+00 | −1.5430300E+00 | −9.9000000E+01 | 2.3434600E+00 | 6.1298500E+00 |
| A4= | 7.5335291E−01 | 4.3848272E−01 | 9.4092496E−01 | 6.6386659E+00 | −1.0790845E−01 |
| A6= | −1.0856346E+00 | 6.4287824E+00 | −4.4606563E+00 | −7.5746054E+02 | 4.4491659E+01 |
| A8= | 1.1939485E+00 | 3.6925783E+01 | −1.5582244E+01 | 7.7840289E+04 | −2.3424808E+03 |
| A10= | −1.0178727E+00 | −8.1711751E+02 | 2.1168103E+02 | −4.9791886E+06 | 6.4226323E+04 |
| A12= | 6.3606976E−01 | 5.7014588E+03 | −1.0763133E+03 | 2.1211137E+08 | −9.5827579E+05 |
| A14= | −2.8230320E−01 | −2.2429590E+04 | 4.4898594E+03 | −6.2841069E+09 | 5.7916104E+06 |
| A16= | 8.7797116E−02 | 5.4441443E+04 | −1.5007143E+04 | 1.3286324E+11 | 3.5167074E+07 |
| A18= | −1.8844896E−02 | −8.3004916E+04 | 3.2294154E+04 | −2.0303465E+12 | −8.2463019E+08 |
| A20= | 2.7089045E−03 | 7.7507155E+04 | −3.7761774E+04 | 2.2457711E+13 | 5.1658865E+09 |
| A22= | −2.4562785E−04 | −4.0531260E+04 | 1.8161610E+04 | −1.7791323E+14 | −1.1549172E+10 |
| A24= | 1.2417325E−05 | 9.0933872E+03 | | 9.8317060E+14 | |
| A26= | −2.5559314E−07 | | | −3.5959609E+15 | |
| A28= | | | | 7.8167206E+15 | |
| A30= | | | | −7.6399304E+15 | |
| Surface # | 8 | 10 | 11 | 12 | 13 |
| k= | 1.7840700E+00 | −2.0806200E−01 | −9.3359800E−01 | −1.0167900E+00 | −1.1484500E+00 |
| A4= | −2.0957218E+01 | −2.2382208E+01 | −1.4917579E+01 | −9.7664061E+00 | 8.7728487E+00 |
| A6= | 6.4353309E+02 | 5.6232881E+02 | 2.1183442E+02 | 1.0921974E+02 | −1.9666334E+02 |
| A8= | −1.4557638E+04 | −1.0729460E+04 | −2.0879169E+03 | −8.6488683E+02 | 2.9601656E+03 |
| A10= | 2.3776783E+05 | 1.4532885E+05 | 1.2610612E+04 | 5.7138870E+03 | −3.0943567E+04 |
| A12= | −2.8144201E+06 | −1.3990803E+06 | −2.3038223E+04 | −3.3525968E+04 | 2.3255722E+05 |
| A14= | 2.3965898E+07 | 9.4205968E+06 | −3.6117651E+05 | 1.6381995E+05 | −1.2709254E+06 |
| A16= | −1.4438830E+08 | −4.3122922E+07 | 4.0154774E+06 | −6.0978320E+05 | 5.0372065E+06 |
| A18= | 5.9721963E+08 | 1.2741266E+08 | −2.1351564E+07 | 1.6333447E+06 | −1.4276398E+07 |
| A20= | −1.6057711E+09 | −2.1865342E+08 | 6.8722832E+07 | −3.0339906E+06 | 2.8119149E+07 |
| A22= | 2.5169694E+09 | 1.6531235E+08 | −1.3582640E+08 | 3.7342882E+06 | −3.6491292E+07 |
| A24= | −1.7381623E+09 | | 1.5219846E+08 | −2.7685161E+06 | 2.8023052E+07 |
| A26= | | | −7.4236339E+07 | 9.4468008E+05 | −9.6397255E+06 |

| Surface # | 15 | 16 |
|---|---|---|
| k= | −1.1330000E+00 | 1.7727400E−01 |
| A4= | 1.1652638E+01 | 4.3106645E+00 |
| A6= | −2.3190808E+02 | −4.4716215E+01 |
| A8= | 3.5853525E+03 | 4.9234354E+02 |
| A10= | −3.9243532E+04 | −3.7521597E+03 |
| A12= | 3.0703422E+05 | 1.9104164E+04 |
| A14= | −1.7326594E+06 | −6.6113930E+04 |
| A16= | 7.0320181E+06 | 1.5614890E+05 |
| A18= | −2.0232959E+07 | −2.4639031E+05 |
| A20= | 4.0094698E+07 | 2.4423231E+05 |
| A22= | −5.1863211E+07 | −1.2964064E+05 |
| A24= | 3.9326674E+07 | 1.7616821E+04 |
| A26= | −1.3239179E+07 | 8.7933960E+03 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
5th Embodiment

| | | | |
|---|---|---|---|
| f [mm] | 0.49 | R6/R8 | −3.53 |
| Fno | 1.82 | R8/R9 | 0.76 |
| HFOV [deg.] | 78.5 | (R11 + R12)/(R11 − R12) | −2.54 |
| FOV [deg.] | 157.0 | (CT1 + T12)/TD | 0.34 |
| TL/ImgH | 4.01 | TD/CT6 | 16.65 |
| f/tan(HFOV) [mm] | 0.10 | CT2/CT4 | 1.03 |
| TL/f | 8.42 | T56/T45 | 0.91 |
| f1/BL | −1.41 | T45/T23 | 0.15 |
| f/CT1 | 1.33 | Vmin | 16.3 |
| f1/TL | −0.26 | V2/V3 | 1.00 |
| f12/BL | −0.78 | ET4/CT4 | 1.57 |
| \|R11\|/f12 | −0.67 | ET1/ET5 | 2.35 |
| f1/CT1 | −2.94 | SAG1R2/SAG1R1 | 1.51 |
| R11/R10 | 0.91 | Y1R1/Y2R1 | 3.16 |
| \|R12/R11\| | 2.30 | ImgH/Y6R2 | 1.42 |

### 6th Embodiment

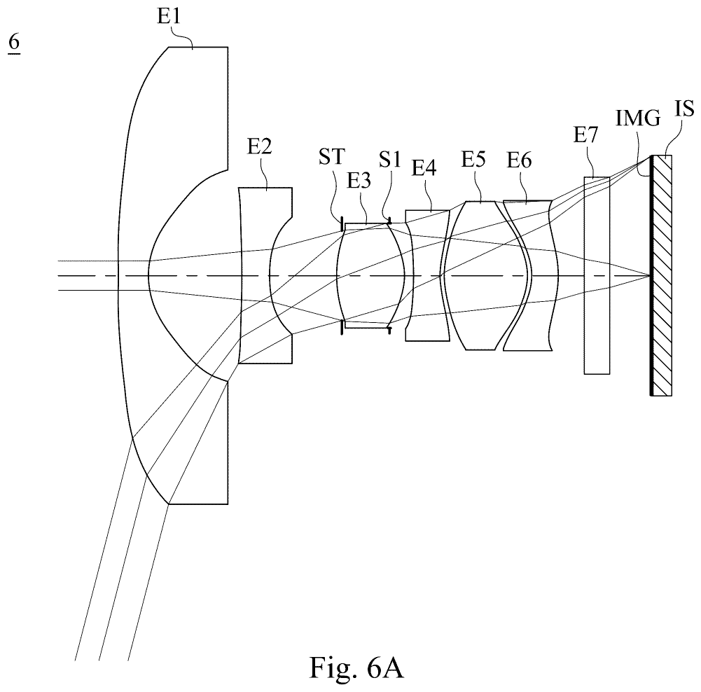

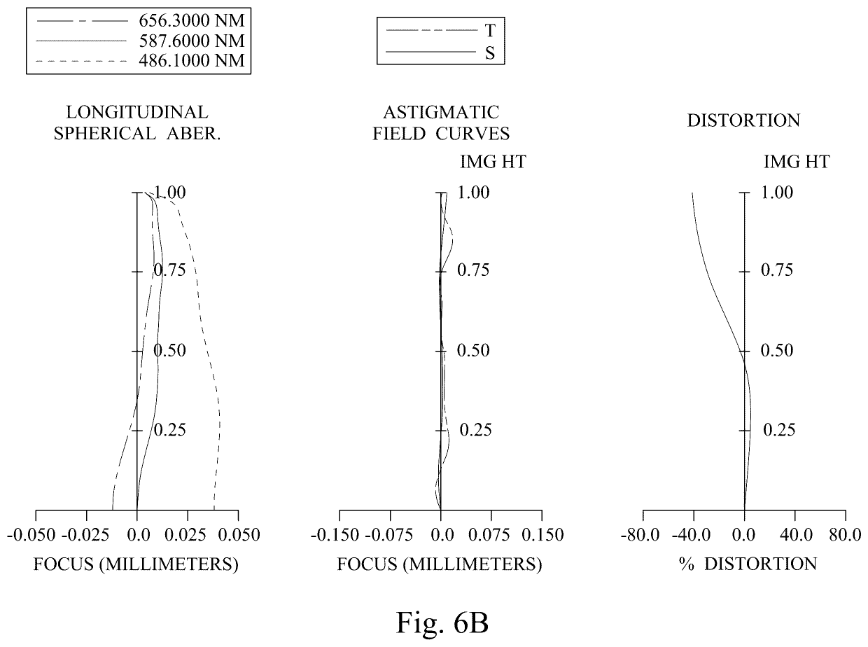

FIG. 6A is a schematic view of an imaging apparatus 6 according to the 6th embodiment of the present disclosure. FIG. 6B shows, in order from left to right, spherical aberration curves, astigmatic field curves and a distortion curve of the imaging apparatus 6 according to the 6th embodiment. In FIG. 6A, the imaging apparatus 6 according to the 6th embodiment includes an optical lens system (its reference number is omitted) and an image sensor IS. The optical lens system includes, in order from an object side to an image side along an optical path, a first lens element E1, a second lens element E2, an aperture stop ST, a third lens element E3, a stop S1, a fourth lens element E4, a fifth lens element E5, a sixth lens element E6, a filter E7 and an image surface IMG, wherein the image sensor IS is disposed on the image surface IMG of the optical lens system. The optical lens system includes six lens elements (E1, E2, E3, E4, E5, E6) without additional one or more lens elements inserted between the first lens element E1 and the sixth lens element E6.

The first lens element E1 with negative refractive power has an object-side surface being concave in a paraxial region thereof and an image-side surface being concave in a paraxial region thereof. The first lens element E1 is made of plastic material, and has the object-side surface and the image-side surface being both aspheric. Moreover, the object-side surface of the first lens element E1 includes three inflection points and one critical point.

The second lens element E2 with negative refractive power has an object-side surface being concave in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes two inflection points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Moreover, the object-side surface of the third lens element E3 includes one inflection point.

The fourth lens element E4 with negative refractive power has an object-side surface being concave in a paraxial region thereof and an image-side surface being concave in a paraxial region thereof. The fourth lens element E4 is made of plastic material, and has the object-side surface and the image-side surface being both aspheric. Moreover, the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Moreover, the image-side surface of the fifth lens element E5 includes one inflection point.

The sixth lens element E6 with negative refractive power has an object-side surface being concave in a paraxial region thereof and an image-side surface being convex in a paraxial region thereof. The sixth lens element E6 is surface being both aspheric. Moreover, the object-side surface of the sixth lens element E6 includes one inflection point, the image-side surface of the sixth lens element E6 includes one inflection point and one critical point.

The filter E7 is made of glass material and disposed between the sixth lens element E6 and the image surface IMG and will not affect a focal length of the optical lens system.

The detailed optical data of the 6th embodiment are shown in Table 6A and the aspheric surface data are shown in Table 6B below.

TABLE 6A
6th Embodiment
f = 0.44 mm, Fno = 1.80, HFOV = 75.5 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | −13.8248 | ASP | 0.250 | Plastic | 1.545 | 56.1 | −1.18 |
| 2 | | 0.6784 | ASP | 0.777 | | | | |
| 3 | Lens 2 | −7.1412 | ASP | 0.230 | Plastic | 1.544 | 56.0 | −1.79 |
| 4 | | 1.1387 | ASP | 0.601 | | | | |
| 5 | Ape. Stop | Plano | | −0.043 | | | | |
| 6 | Lens 3 | 1.0728 | ASP | 0.564 | Plastic | 1.544 | 56.0 | 0.71 |
| 7 | | −0.4897 | ASP | −0.125 | | | | |
| 8 | Stop | Plano | | 0.200 | | | | |
| 9 | Lens 4 | −2.1940 | ASP | 0.220 | Plastic | 1.669 | 19.5 | −0.69 |
| 10 | | 0.6040 | ASP | 0.035 | | | | |
| 11 | Lens 5 | 0.6350 | ASP | 0.692 | Plastic | 1.544 | 56.0 | 0.63 |
| 12 | | −0.4616 | ASP | 0.036 | | | | |
| 13 | Lens 6 | −0.4410 | ASP | 0.220 | Plastic | 1.669 | 19.5 | −1.73 |
| 14 | | −0.8552 | ASP | 0.217 | | | | |

| | | | | | | | |
|---|---|---|---|---|---|---|---|
| 15 | Filter | Plano | 0.210 | Glass | 1.517 | 64.2 | — |
| 16 | | Plano | 0.349 | | | | |
| 17 | Image | Plano | — | | | | |

Reference wavelength is 587.6 nm (d-line).
Effective radius of Surface 8 (Stop S1) is 0.436 mm.

TABLE 6B
Aspheric Coefficients

| Surface # | 1 | 2 | 3 | 4 | 6 |
|---|---|---|---|---|---|
| k= | 0.0000000E+00 | −1.0000000E+00 | 2.0444700E+01 | 1.2242300E+00 | −1.1310700E+00 |
| A4= | 4.4091769E−01 | −3.2577239E−01 | 1.6678208E−01 | 1.1797204E+00 | 2.5967553E−01 |
| A6= | −8.2001401E−01 | 9.3310641E+00 | −1.9151249E+00 | −6.7514765E+00 | 3.4279864E+00 |
| A8= | 8.2388447E−01 | −7.1992297E+01 | 1.7925532E+01 | 1.0607211E+02 | −9.2982701E+01 |
| A10= | −5.0653061E−01 | 3.0418882E+02 | −7.2300520E+01 | −4.5155400E+02 | 9.2182901E+02 |
| A12= | 2.0301267E−01 | −8.3484927E+02 | 1.3969430E+02 | −2.9577480E+02 | −4.5227516E+03 |
| A14= | −5.3549723E−02 | 1.5068717E+03 | −1.3087046E+02 | 5.3774472E+03 | 7.4253769E+03 |
| A16= | 9.0031721E−03 | −1.7046035E+03 | 4.8140621E+01 | −7.6856058E+03 | 3.9500065E+03 |
| A18= | −8.7761867E−04 | 1.0898093E+03 | | | |
| A20= | 3.7892879E−05 | −2.9882468E+02 | | | |
| Surface # | 7 | 9 | 10 | 11 | 12 |
| k= | −2.0215300E−01 | −9.8591300E+01 | −1.6772100E−01 | −1.0000000E+00 | −1.0000000E+00 |
| A4= | 5.5725832E+00 | 9.7400709E−01 | −8.0461740E+00 | −6.1114559E+00 | 3.8794830E+00 |
| A6= | −5.1841453E+01 | −2.4220650E+01 | 8.2508434E+01 | 6.6238857E+01 | −1.8080917E+01 |
| A8= | 4.7560708E+02 | 1.8621240E+02 | −7.6514205E+02 | −5.1932381E+02 | −4.2225797E+01 |
| A10= | −3.0495971E+03 | −1.0501860E+03 | 5.1058715E+03 | 2.9455404E+03 | 6.4101542E+02 |
| A12= | 1.2397464E+04 | 3.4682695E+03 | −2.2878265E+04 | −1.1493985E+04 | −1.8560272E+03 |
| A14= | −2.7993512E+04 | −7.0070408E+03 | 6.4326666E+04 | 2.9464728E+04 | 1.5005478E+03 |
| A16= | 2.6870701E+04 | 6.7478671E+03 | −1.0416746E+05 | −4.7009052E+04 | 2.9038369E+01 |
| A18= | | | 8.0518732E+04 | 4.2265941E+04 | 3.7892744E+03 |
| A20= | | | −1.5607971E+04 | −1.6393186E+04 | −6.2584928E+03 |

| Surface # | 13 | 14 |
|---|---|---|
| k= | −1.0000000E+00 | −2.3543400E−01 |
| A4= | 3.8331835E+00 | 8.8735426E−01 |
| A6= | −2.0451265E+00 | 1.5811435E+01 |
| A8= | −2.2478619E+02 | −1.9755148E+02 |
| A10= | 1.2873143E+03 | 1.2547845E+03 |
| A12= | 2.5454733E+02 | −5.1118528E+03 |
| A14= | −2.2793910E+04 | 1.4631753E+04 |
| A16= | 7.9417188E+04 | −2.7988484E+04 |
| A18= | −1.1396733E+05 | 3.0986748E+04 |
| A20= | 6.1337035E+04 | −1.4702968E+04 |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
6th Embodiment

| | | | |
|---|---|---|---|
| f[mm] | 0.44 | R6/R8 | −0.81 |
| Fno | 1.80 | R8/R9 | 0.95 |
| HFOV [deg.] | 75.5 | (R11 + R12)/(R11 − R12) | −3.13 |
| FOV [deg.] | 151.0 | (CT1 + T12)/TD | 0.28 |
| TL/ImgH | 4.45 | TD/CT6 | 16.62 |
| f/tan(HFOV) [mm] | 0.11 | CT2/CT4 | 1.05 |
| TL/f | 10.11 | T56/T45 | 1.03 |
| f1/BL | −1.52 | T45/T23 | 0.06 |
| f/CT1 | 1.75 | Vmin | 19.5 |
| f1/TL | −0.27 | V2/V3 | 1.00 |
| f12/BL | −0.70 | ET4/CT4 | 1.66 |
| \|R11\|/f12 | −0.81 | ET1/ET5 | 2.03 |
| f1/CT1 | −4.72 | SAG1R2/SAG1R1 | 1.58 |
| R11/R10 | 0.96 | Y1R1/Y2R1 | 2.60 |
| \|R12/R11\| | 1.94 | ImgH/Y6R2 | 1.60 |

### 7th Embodiment

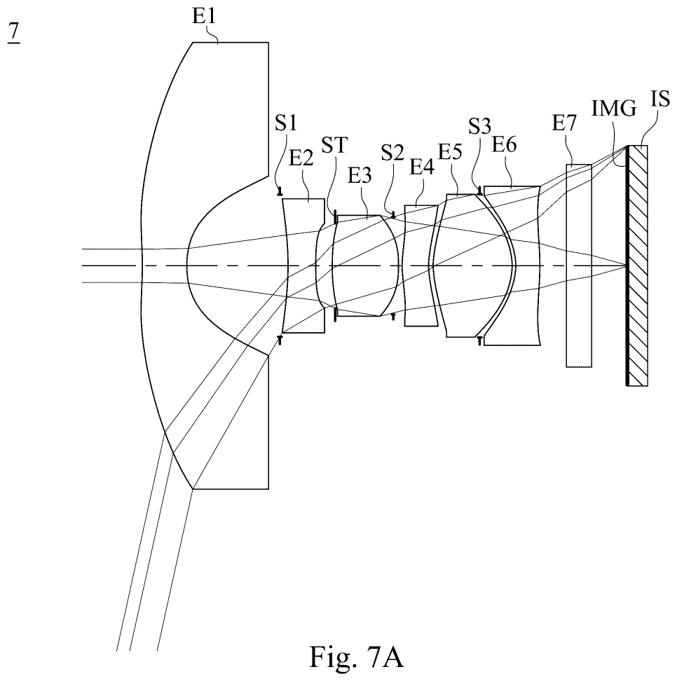

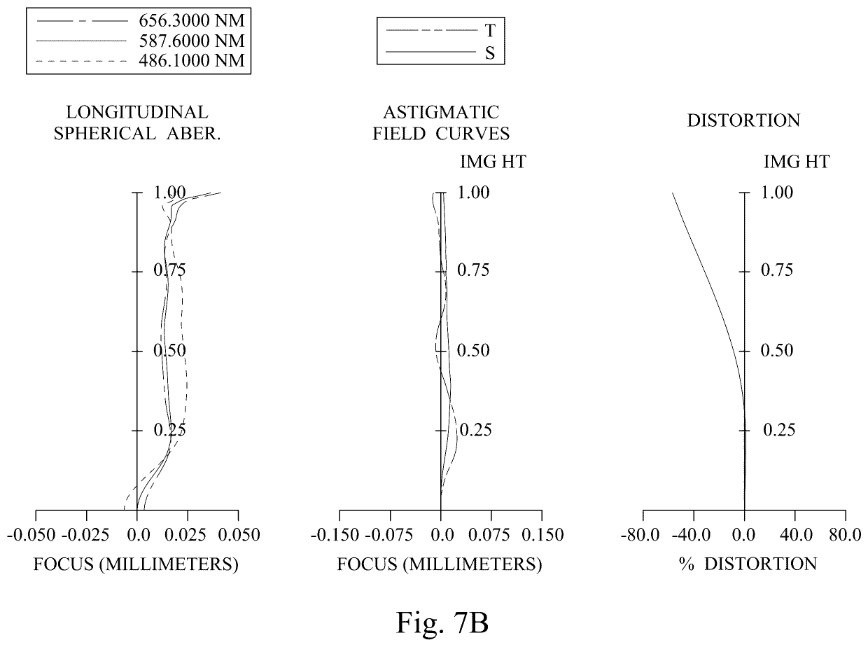

FIG. 7A is a schematic view of an imaging apparatus 7 according to the 7th embodiment of the present disclosure. FIG. 7B shows, in order from left to right, spherical aberration curves, astigmatic field curves and a distortion curve of the imaging apparatus 7 according to the 7th embodiment. In FIG. 7A, the imaging apparatus 7 according to the 7th embodiment includes an optical lens system (its reference number is omitted) and an image sensor IS. The optical lens system includes, in order from an object side to an image side along an optical path, a first lens element E1, a stop S1, a second lens element E2, an aperture stop ST, a third lens element E3, a stop S2, a fourth lens element E4, a fifth lens element E5, a stop S3, a sixth lens element E6, a filter E7 and an image surface IMG, wherein the image sensor IS is disposed on the image surface IMG of the optical lens system. The optical lens system includes six lens elements (E1, E2, E3, E4, E5, E6) without additional one or more lens elements inserted between the first lens element E1 and the sixth lens element E6.

The first lens element E1 with negative refractive power has an object-side surface being concave in a paraxial region thereof and an image-side surface being concave in a paraxial region thereof. The first lens element E1 is made of plastic material, and has the object-side surface and the image-side surface being both aspheric. Moreover, the object-side surface of the first lens element E1 includes one inflection point and one critical point, the image-side surface of the first lens element E1 includes two inflection points.

The second lens element E2 with negative refractive power has an object-side surface being concave in a paraxial region thereof and an image-side surface being concave in a paraxial region thereof. The second lens element E2 is made of plastic material, and has the object-side surface and the image-side surface being both aspheric. Moreover, the object-side surface of the second lens element E2 includes one inflection point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric.

The fourth lens element E4 with positive refractive power has an object-side surface being convex in a paraxial region thereof and an image-side surface being concave in a paraxial region thereof. The fourth lens element E4 is made of plastic material, and has the object-side surface and the image-side surface being both aspheric. Moreover, the object-side surface of the fourth lens element E4 includes one inflection point and one critical point, the image-side surface of the fourth lens element E4 includes two inflection points.

The fifth lens element E5 with positive refractive power has an object-side surface being convex in a paraxial region thereof and an image-side surface being convex in a paraxial region thereof. The fifth lens element E5 is made of glass material, and has the object-side surface and the image-side surface being both aspheric. Moreover, the object-side surface of the fifth lens element E5 includes two inflection points, the image-side surface of the fifth lens element E5 includes one inflection point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Moreover, the object-side surface of the sixth lens element E6 includes one inflection point, the image-side surface of the sixth lens element E6 includes one inflection point and one critical point.

The filter E7 is made of glass material and disposed between the sixth lens element E6 and the image surface IMG and will not affect a focal length of the optical lens system.

The detailed optical data of the 7th embodiment are shown in Table 7A and the aspheric surface data are shown in Table 7B below.

TABLE 7A
7th Embodiment
f = 0.51 mm, Fno = 1.82, HFOV = 77.6 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | −2.6378 | ASP | 0.369 | Plastic | 1.545 | 56.1 | −1.05 |
| 2 | | 0.7669 | ASP | 0.773 | | | | |
| 3 | Stop | Plano | | 0.068 | | | | |
| 4 | Lens 2 | −2.2713 | ASP | 0.230 | Plastic | 1.544 | 56.0 | −2.58 |
| 5 | | 3.7997 | ASP | 0.161 | | | | |
| 6 | Ape. Stop | Plano | | −0.024 | | | | |
| 7 | Lens 3 | 1.8798 | ASP | 0.550 | Plastic | 1.544 | 56.0 | 2.10 |
| 8 | | −2.6119 | ASP | −0.043 | | | | |
| 9 | Stop | Plano | | 0.073 | | | | |
| 10 | Lens 4 | 0.6101 | ASP | 0.220 | Plastic | 1.680 | 18.2 | 17.33 |
| 11 | | 0.5495 | ASP | 0.038 | | | | |
| 12 | Lens 5 | 0.5530 | ASP | 0.657 | Glass | 1.540 | 59.7 | 0.60 |
| 13 | | −0.4515 | ASP | −0.270 | | | | |
| 14 | Stop | Plano | | 0.300 | | | | |
| 15 | Lens 6 | −0.4145 | ASP | 0.200 | Plastic | 1.669 | 19.5 | −0.90 |
| 16 | | −1.5689 | ASP | 0.220 | | | | |

| | | | | | | | |
|---|---|---|---|---|---|---|---|
| 17 | Filter | Plano | 0.210 | Glass | 1.517 | 64.2 | — |
| 18 | | Plano | 0.297 | | | | |
| 19 | Image | Plano | — | | | | |

Reference wavelength is 587.6 nm (d-line).
Effective radius of Surface 3 (Stop S1) is 0.591 mm.
Effective radius of Surface 9 (Stop S2) is 0.405 mm.
Effective radius of Surface 14 (Stop S3) is 0.595 mm.

TABLE 7B
Aspheric Coefficients

| Surface # | 1 | 2 | 4 | 5 | 7 |
|---|---|---|---|---|---|
| k= | −6.4525700E−01 | −5.0000900E−01 | −4.4225000E+01 | 1.8122400E+01 | 1.0504500E+01 |
| A4= | 1.0585925E+00 | 8.9692409E−01 | 2.6202485E−01 | 4.6693575E+00 | −3.2847720E−02 |
| A6= | −2.3215013E+00 | 1.5524136E+01 | −9.3565574E+00 | −4.4347036E+02 | 4.8473683E+01 |
| A8= | 3.4693469E+00 | −2.1549742E+02 | 2.1697086E+02 | 4.8142386E+04 | −2.7460794E+03 |
| A10= | −3.6332200E+00 | 1.8146995E+03 | −3.2348630E+03 | −3.1977666E+06 | 8.9796531E+04 |
| A12= | 2.7229925E+00 | −1.1120857E+04 | 2.9874173E+04 | 1.4011082E+08 | −1.9001644E+06 |
| A14= | −1.4766563E+00 | 4.8738415E+04 | −1.7552115E+05 | −4.2317735E+09 | 2.6491491E+07 |
| A16= | 5.8005574E−01 | −1.4680450E+05 | 6.6147412E+05 | 9.0510812E+10 | −2.4089421E+08 |
| A18= | −1.6333938E−01 | 2.9332196E+05 | −1.5515549E+06 | −1.3901362E+12 | 1.3721393E+09 |
| A20= | 3.2121170E−02 | −3.6979066E+05 | 2.0640899E+06 | 1.5370839E+13 | −4.4355964E+09 |
| A22= | −4.1868780E−03 | 2.6560215E+05 | −1.1903328E+06 | −1.2117260E+14 | 6.1991078E+09 |
| A24= | 3.2492105E−04 | −8.2674114E+04 | | 6.6364975E+14 | |
| A26= | −1.1360942E−05 | | | −2.3965034E+15 | |
| A28= | | | | 5.1230088E+15 | |
| A30= | | | | −4.9022361E+15 | |
| Surface # | 8 | 10 | 11 | 12 | 13 |
| k= | 9.3035800E+00 | −8.7355100E−02 | −8.6455800E−01 | −1.0605600E+00 | −9.8076600E−01 |
| A4= | −2.3516755E+01 | −2.1180718E+01 | −1.1959269E+01 | −9.9968005E+00 | 8.0816954E+00 |
| A6= | 6.7403219E+02 | 5.1617984E+02 | 1.7092753E+02 | 1.4614180E+02 | −1.5055428E+02 |
| A8= | −1.5003278E+04 | −1.0066627E+04 | −1.7975120E+03 | −1.8904061E+03 | 1.8356053E+03 |
| A10= | 2.4703266E+05 | 1.4309195E+05 | 1.2916071E+04 | 2.1981826E+04 | −1.7839981E+04 |
| A12= | −2.9902909E+06 | −1.4577762E+06 | −6.0994395E+04 | −2.1486107E+05 | 1.4971649E+05 |
| A14= | 2.6431404E+07 | 1.0420637E+07 | 1.8265854E+05 | 1.6274776E+06 | −1.0158460E+06 |
| A16= | −1.6835039E+08 | −5.0733457E+07 | −4.7580763E+05 | −9.0953765E+06 | 5.0859134E+06 |
| A18= | 7.5231631E+08 | 1.5966790E+08 | 2.6796797E+06 | 3.6377220E+07 | −1.7748159E+07 |
| A20= | −2.2389459E+09 | −2.9226854E+08 | −1.5669678E+07 | −1.0074736E+08 | 4.1428638E+07 |
| A22= | 3.9861985E+09 | 2.3603225E+08 | 5.2149888E+07 | 1.8296630E+08 | −6.1205130E+07 |
| A24= | −3.2118458E+09 | | −8.8748742E+07 | −1.9550545E+08 | 5.1355027E+07 |
| A26= | | | 6.1114997E+07 | 9.2943376E+07 | −1.8449292E+07 |

| Surface # | 15 | 16 |
|---|---|---|
| k= | −9.7311200E−01 | 1.5480000E+00 |
| A4= | 1.1246987E+01 | 3.9628813E+00 |
| A6= | −2.0199847E+02 | −4.3559539E+01 |
| A8= | 2.7147588E+03 | 4.3076294E+02 |
| A10= | −3.1352482E+04 | −3.7959056E+03 |
| A12= | 3.0688065E+05 | 2.7801178E+04 |
| A14= | −2.3031266E+06 | −1.5285338E+05 |
| A16= | 1.2383433E+07 | 5.9806350E+05 |
| A18= | −4.6120386E+07 | −1.6217864E+06 |
| A20= | 1.1557649E+08 | 2.9663911E+06 |
| A22= | −1.8564154E+08 | −3.4859249E+06 |
| A24= | 1.7253752E+08 | 2.3745134E+06 |
| A26= | −7.0554033E+07 | −7.1245816E+05 |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
7th Embodiment

| | | | |
|---|---|---|---|
| f [mm] | 0.51 | R6/R8 | −4.75 |
| Fno | 1.82 | R8/R9 | 0.99 |
| HFOV [deg.] | 77.6 | (R11 + R12)/(R11 − R12) | −1.72 |
| FOV [deg.] | 155.2 | (CT1 + T12)/TD | 0.37 |
| TL/ImgH | 4.05 | TD/CT6 | 16.51 |
| f/tan(HFOV) [mm] | 0.11 | CT2/CT4 | 1.05 |
| TL/f | 7.97 | T56/T45 | 0.79 |
| f1/BL | −1.44 | T45/T23 | 0.28 |
| f/CT1 | 1.37 | Vmin | 18.2 |
| f1/TL | −0.26 | V2/V3 | 1.00 |
| f12/BL | −0.81 | ET4/CT4 | 1.26 |
| \|R11\|/f12 | −0.70 | ET1/ET5 | 2.68 |
| f1/CT1 | −2.85 | SAG1R2/SAG1R1 | 1.62 |
| R11/R10 | 0.92 | Y1R1/Y2R1 | 3.33 |
| \|R12/R11\| | 3.79 | ImgH/Y6R2 | 1.51 |

### 8th Embodiment

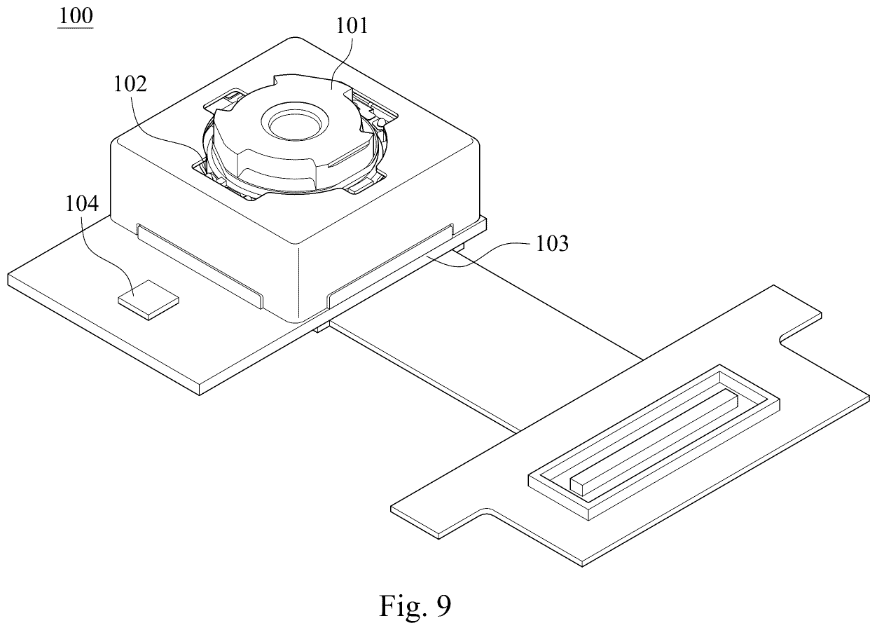

FIG. 9 is a three-dimensional schematic view of an imaging apparatus 100 according to the 8th embodiment of the present disclosure. In FIG. 9, the imaging apparatus 100 of the 8th embodiment is a camera module, the imaging apparatus 100 includes an imaging lens assembly 101, a driving apparatus 102 and an image sensor 103, wherein the imaging lens assembly 101 includes the optical lens system of the present disclosure and a lens barrel (its reference number is omitted) for carrying the optical lens system. The imaging apparatus 100 can focus light from an imaged object via the imaging lens assembly 101, perform image focusing by the driving apparatus 102, and generate an image on the image sensor 103, and the imaging information can be transmitted.

The driving apparatus 102 can have auto-focus function, which can be driven by driving systems, such as voice coil motors (VCM), micro electro-mechanical systems (MEMS), piezoelectric systems, or shape memory alloys, etc. The imaging lens assembly 101 can obtain a favorable imaging position by the driving apparatus 102 so as to capture clear images when the imaged object is disposed at different object distances. Moreover, the imaging apparatus 100 can include the image sensor 103 located on the image surface of the optical lens system, such as CMOS and CCD, with superior photosensitivity and low noise. Thus, it is favorable for providing realistic images with high definition image quality thereof.

The imaging apparatus 100 can further include an image stabilization module 104, which can be a kinetic energy sensor, such as an accelerometer, a gyro sensor, and a Hall Effect sensor. The driving apparatus 102 can be used with the image stabilization module 104 as an optical image stabilization (OIS) device to compensate for blurry images caused by shaking at the moment of shooting by adjusting changes in different axial directions of the imaging lens assembly 101. Alternatively, the image compensation technology in imaging software is used to provide electronic image stabilization (EIS) function to further improve the imaging quality of dynamic and low illumination scene shooting.

### 9th Embodiment

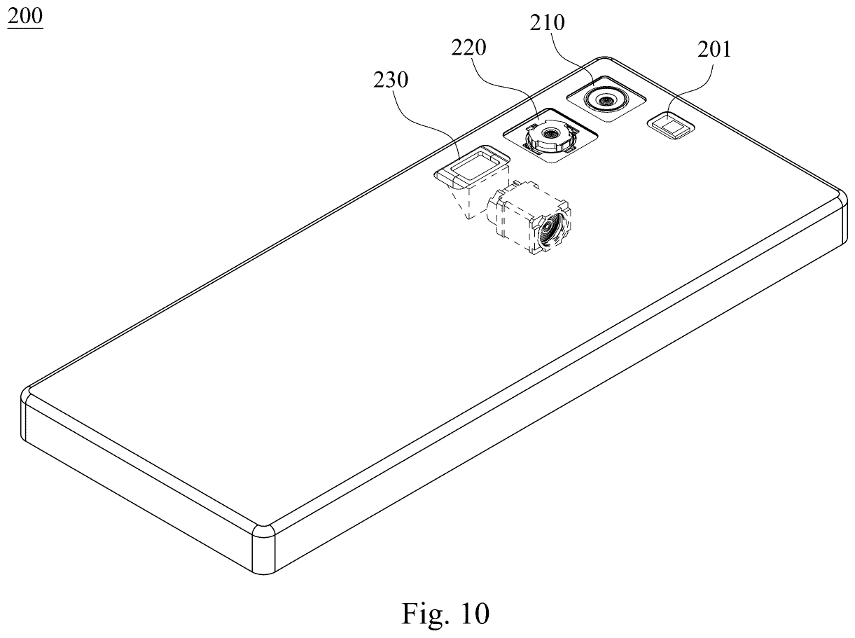

FIG. 10 is a schematic view of one side of an electronic device 200 according to the 9th embodiment of the present disclosure. According to the 9th embodiment, the electronic device 200 is a smartphone, which include imaging apparatuses 210, 220, 230 and a flash module 201.

According to the 9th embodiment, each of the imaging apparatuses 210, 220, 230 can include the optical lens system of the present disclosure, and can be the same or similar to the imaging apparatus 100 according to the aforementioned 8th embodiment, and will not describe again herein. In detail, the imaging apparatus 210 can be ultra-wide angle imaging apparatus, the imaging apparatus 220 can be wide angle imaging apparatus, the imaging apparatus 230 can be telephoto imaging apparatus (which can include light path folding element), or can be adaptively adjusted according to the type of the imaging apparatuses, which will not be limited to the arrangement.

### 10th Embodiment

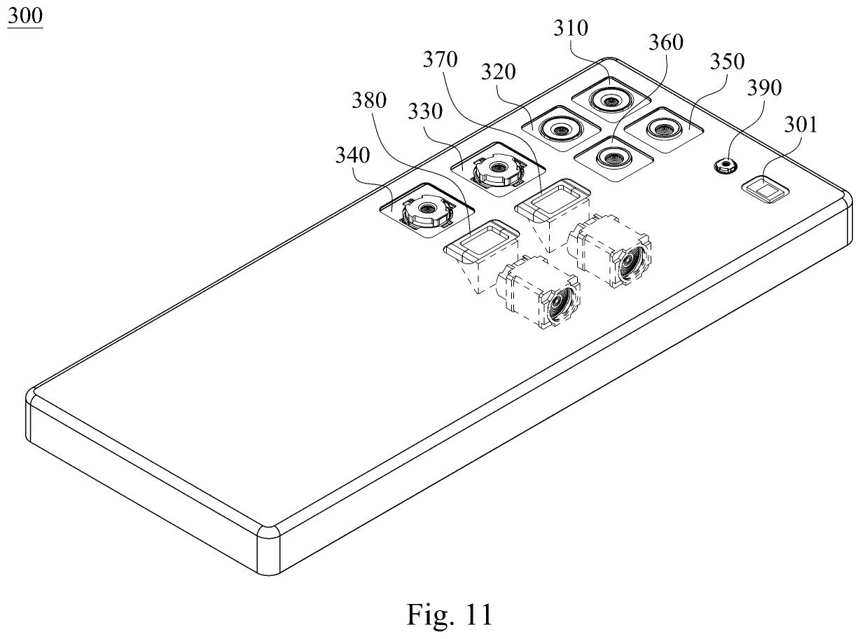

FIG. 11 is a schematic view of one side of an electronic device 300 according to the 10th embodiment of the present disclosure. According to the 10th embodiment, the electronic device 300 is a smartphone, which include imaging apparatuses 310, 320, 330, 340, 350, 360, 370, 380, 390 and a flash module 301. According to the 10th embodiment, each of the imaging apparatuses 310, 320, 330, 340, 350, 360, 370, 380, 390 can include the optical lens system of the present disclosure, and can be the same or similar to the imaging apparatus 100 according to the aforementioned 8th embodiment, and will not describe again herein.

In detail, each of the imaging apparatuses 310, 320 can be ultra-wide angle imaging apparatus, each of the imaging apparatuses 330, 340 can be wide angle imaging apparatus, each of the imaging apparatuses 350, 360 can be telephoto imaging apparatus, each of the imaging apparatuses 370, 380 can be telephoto imaging apparatus (which can include light path folding element), the imaging apparatus 390 can be TOF (Time-Of-Flight) module, or can be adaptively adjusted according to the type of the imaging apparatuses, which will not be limited to the arrangement.

### 11th Embodiment

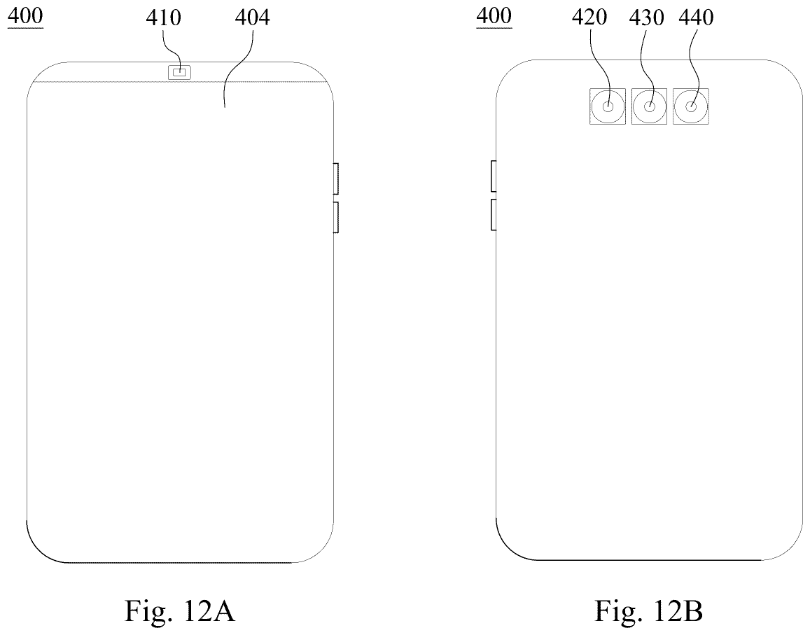

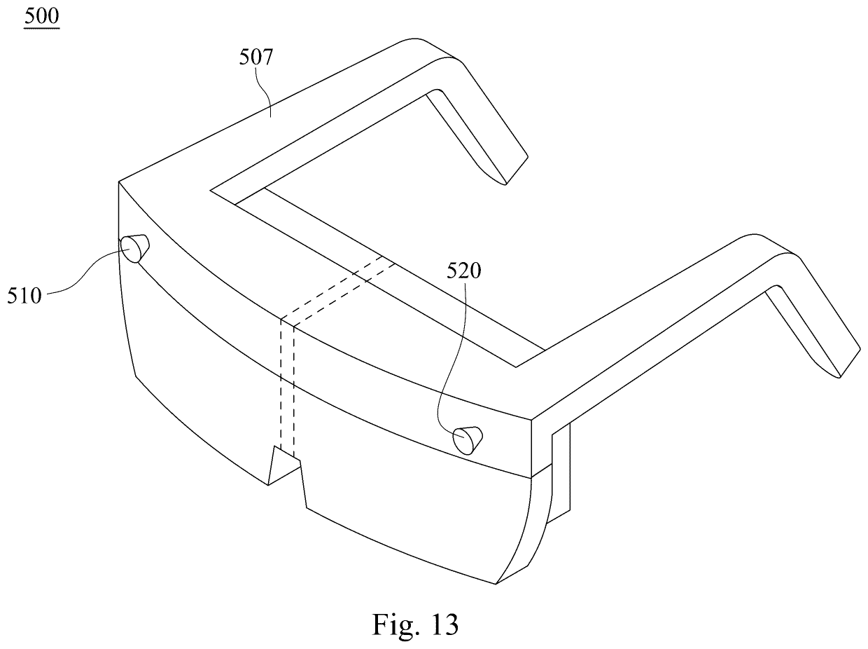

FIG. 12A is a schematic view of one side of an electronic device 400 according to the 11th embodiment of the present disclosure. FIG. 12B is a schematic view of another side of the electronic device 400 of FIG. 12A. In FIG. 12A and FIG. 12B, according to the 11th embodiment, the electronic device 400 is a smartphone, which include imaging apparatuses 410, 420, 430, 440 and a user interface 404.

In detail, the imaging apparatus 410 corresponds to a non-circular opening located on an outer side of the electronic device 400 for capturing the image, and the imaging apparatuses 420, 430, 440 can be telephoto imaging apparatus, wide angle imaging apparatus and ultra-wide angle imaging apparatus, respectively, or can be adaptively adjusted according to the type of the imaging apparatuses, which will not be limited to the arrangement.

### 12th Embodiment

FIG. 13 is a three-dimensional schematic view of an electronic device 500 according to the 12th embodiment of the present disclosure. In FIG. 13, the electronic device 500 of the 12th embodiment is a head-mounted device, the electronic device 500 includes a main body 507 and imaging apparatuses 510, 520.

In detail, the imaging apparatuses 510, 520 are arranged on the main body 507 and can be disposed on two sides of the main body 507. According to the 12th embodiment, each of the imaging apparatuses 510, 520 can include the optical lens system of the present disclosure, and can be the same or similar to the imaging apparatus 100 according to the aforementioned 8th embodiment, and will not describe again herein.

### 13th Embodiment

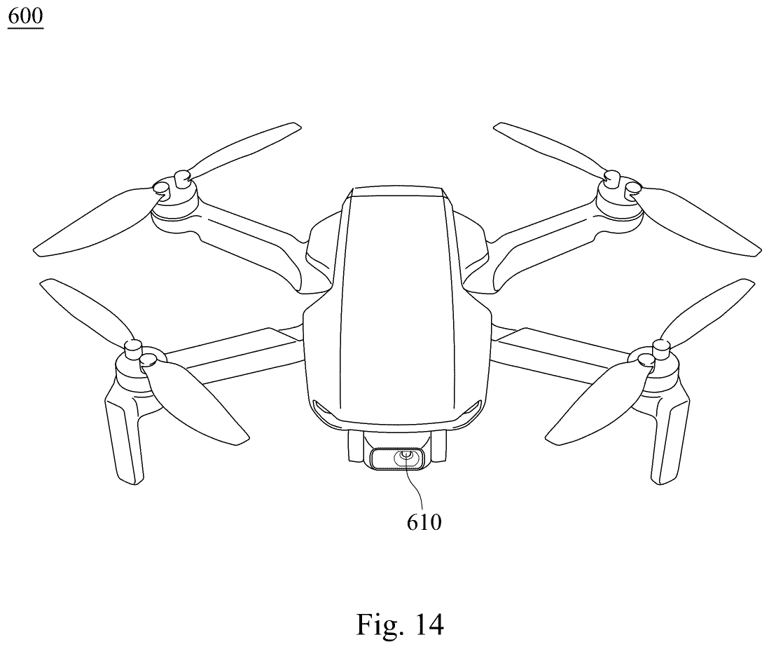

FIG. 14 is a three-dimensional schematic view of an electronic device 600 according to the 13th embodiment of the present disclosure. In FIG. 14, the electronic device 600 of the 13th embodiment is a drone, which includes an imaging apparatus 610. The imaging apparatus 610 can include the optical lens system of the present disclosure, and can be the same or similar to the imaging apparatus 100 according to the aforementioned 8th embodiment, and will not describe again herein.

### 14th Embodiment

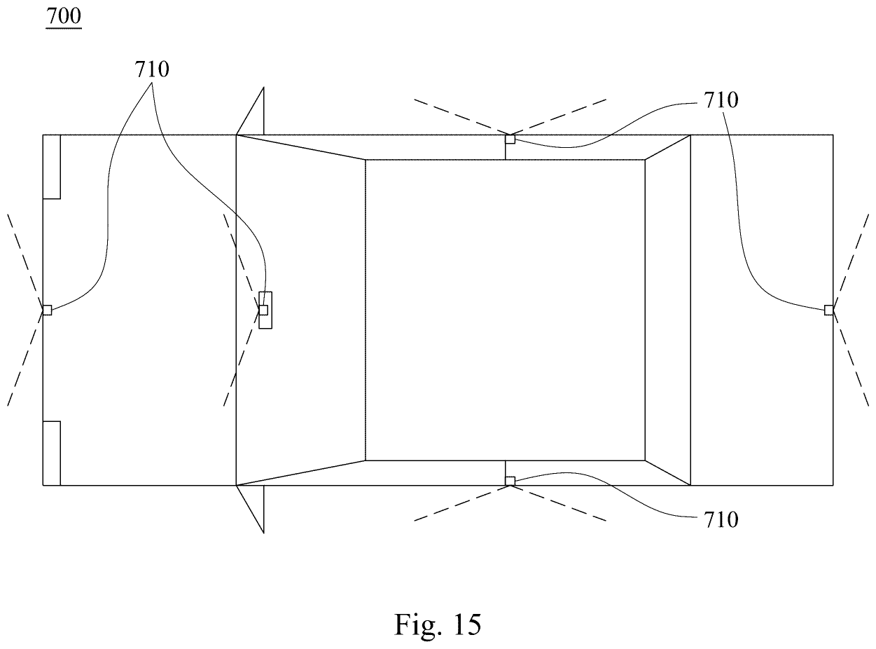

FIG. 15 is a top view of a vehicle device 700 according to the 14th embodiment of the present disclosure. In FIG. 15, the vehicle device 700 includes a plurality of imaging apparatuses 710. Each of the plurality of imaging apparatuses 710 can include the optical lens system of the present disclosure, and can be the same or similar to the imaging apparatus 100 according to the aforementioned 8th embodiment, and will not describe again herein.

In detail, the plurality of imaging apparatuses 710 can be arranged at the front side, the rear side, the rearview mirror, the door gaps on both sides or other locations of the vehicle device 700, which will not be limited to the arrangement.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical lens system comprising six lens elements from an object side to an image side, the six lens elements being, in order from the object side to the image side:
a first lens element, a second lens element, a third lens element, a fourth lens element, a fifth lens element and a sixth lens element; each of the six lens elements has an object-side surface towards the object side and an image-side surface towards the image side;
wherein the image-side surface of the second lens element is concave in a paraxial region thereof;
the third lens element has positive refractive power;
the image-side surface of the fourth lens element is concave in a paraxial region thereof; and
the image-side surface of the sixth lens element comprises at least one inflection point;
wherein a focal length of the optical lens system is f, a focal length of the first lens element is f1, a composite focal length of the first lens element and the second lens element is f12, a central thickness of the first lens element is CT1, an axial distance between the first lens element and the second lens element is T12, a curvature radius of the image-side surface of the fifth lens element is R10, a curvature radius of the object-side surface of the sixth lens element is R11, an axial distance between the object-side surface of the first lens element to the image-side surface of the sixth lens element is TD, an axial distance between the object-side surface of the first lens element to an image surface is TL, and the following conditions are satisfied:
$$0.25 < ( CT 1 + T 12 ) / TD < 40 ;$$
$$0.2 < R 11 / R 10 < 3.3 ;$$
$$6. < TL / f < 13. ;$$
$$- 1.6 < \vert R 11 \vert / f 12 < - 0.5 ; and$$
$$- 6.4 < 1 / CT 1 < 0. .$$

2. The optical lens system of claim 1, wherein the first lens element has negative refractive power, the image-side surface of the first lens element is concave in a paraxial region thereof; the object-side surface of the third lens element is convex in a paraxial region thereof.

3. The optical lens system of claim 1, wherein the image-side surface of the third lens element is convex in a paraxial region thereof; the object-side surface of the fifth lens element is convex in a paraxial region thereof; there is an air gap on an optical axis between each of adjacent lens elements of the six lens elements.

4. The optical lens system of claim 1, wherein the curvature radius of the object-side surface of the sixth lens element is R11, a curvature radius of the image-side surface of the sixth lens element is R12, and the following condition is satisfied:
$$0.9 < \vert R 12 / R 11 \vert < 20. .$$

5. The optical lens system of claim 1, wherein an axial distance between the fourth lens element and the fifth lens element is T45, an axial distance between the fifth lens element and the sixth lens element is T56, and the following condition is satisfied:
$$0.05 < T 56 / T 45 < 10. .$$

6. The optical lens system of claim 1, wherein the focal length of the first lens element is f1, an axial distance between the image-side surface of the sixth lens element and the image surface is BL, the central thickness of the first lens element is CT1, and the following conditions are satisfied:
$$- 2.6 < 1 / BL < 0. ; and$$
$$- 5.5 < f 1 / CT 1 < - 2. .$$

7. The optical lens system of claim 1, wherein a central thickness of the second lens element is CT2, a central thickness of the fourth lens element is CT4, and the following condition is satisfied:
$$0.65 < CT 2 / CT 4 < 1.7 .$$

8. The optical lens system of claim 1, further comprising:
an aperture stop, disposed between the second lens element and the third lens element.

9. The optical lens system of claim 1, wherein an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the sixth lens element is V6, a minimum among V1, V2, V3, V4, V5, V6 is Vmin, and the following condition is satisfied:
$$8. \leq {V}_{min} \leq 22. .$$

10. The optical lens system of claim 1, wherein a curvature radius of the image-side surface of the third lens element is R6, a curvature radius of the image-side surface of the fourth lens element is R8, and the following condition is satisfied:
$$- 20. < R 6 / R 8 < - 0.2 .$$

11. The optical lens system of claim 1, wherein a distance in parallel with an optical axis from an axial vertex on the object-side surface of the first lens element to a maximum effective radius position on the object-side surface of the first lens element is SAG1R1, a distance in parallel with the optical axis from an axial vertex on the image-side surface of the first lens element to a maximum effective radius position on the image-side surface of the first lens element is SAG1R2, a maximum effective radius of the object-side surface of the first lens element is Y1R1, a maximum effective radius of the object-side surface of the second lens element is Y2R1, and the following conditions are satisfied:
$$1. < SAG 1 R 2 / SAG 1 R 1 < 4.5 ; and \\ 1.6 < Y 1 R 1 / Y 2 R 1 < 4.50 .$$

12. The optical lens system of claim 1, wherein a distance in parallel with an optical axis between a maximum effective radius position of an optically effective area of the object-side surface of the first lens element to a maximum effective radius position of an optically effective area of the image-side surface of the first lens element is ET1, a distance in parallel with the optical axis between a maximum effective radius position of an optically effective area of the object-side surface of the fifth lens element to a maximum effective radius position of an optically effective area of the image-side surface of the fifth lens element is ET5, and the following condition is satisfied:
$$1. 50 < ET 1 / ET 5 < 5.00 .$$

13. An imaging apparatus, comprising:
the optical lens system of claim 1; and
an image sensor disposed on the image surface of the optical lens system.

14. An electronic device, comprising:
the imaging apparatus of claim 13.

15. An optical lens system comprising six lens elements from an object side to an image side, the six lens elements being, in order from the object side to the image side:
a first lens element, a second lens element, a third lens element, a fourth lens element, a fifth lens element and a sixth lens element; each of the six lens elements has an object-side surface towards the object side and an image-side surface towards the image side;
wherein the image-side surface of the second lens element is concave in a paraxial region thereof;
the third lens element with positive refractive power has the object-side surface being convex in a paraxial region thereof and the image-side surface being convex in a paraxial region thereof;
the image-side surface of the fourth lens element is concave in a paraxial region thereof;
the object-side surface of the fifth lens element is convex in a paraxial region thereof; and
the image-side surface of the sixth lens element comprises at least one inflection point;
wherein there is an air gap on an optical axis between each of adjacent lens elements of the six lens elements; a focal length of the optical lens system is f, a central thickness of the first lens element is CT1, an axial distance between the first lens element and the second lens element is T12, the axial distance between the second lens element and the third lens element is T23, the axial distance between the fourth lens element and the fifth lens element is T45, a curvature radius of the image-side surface of the fifth lens element is R10, a curvature radius of the object-side surface of the sixth lens element is R11, an axial distance between the object-side surface of the first lens element to the image-side surface of the sixth lens element is TD, an axial distance between the object-side surface of the first lens element to an image surface is TL, and the following conditions are satisfied:
$$0.22 < ( C T 1 + T 12 ) / TD < 0.45 ; \\ 0.2 < R 11 / R 10 < 1.5 ; \\ 6. < TL / f < 1 3. ; and \\ 0.04 < T 45 / T 23 < 1.10 .$$

16. The optical lens system of claim 15, wherein the first lens element has negative refractive power, the image-side surface of the first lens element is concave in a paraxial region thereof, the image-side surface of the sixth lens element comprises at least one concave critical point.

17. The optical lens system of claim 15, wherein a curvature radius of the image-side surface of the fourth lens element is R8, a curvature radius of the object-side surface of the fifth lens element is R9, and the following condition is satisfied:
$$0. 20 < R 8 / R 9 < 2.50 .$$

18. The optical lens system of claim 15, wherein the axial distance between the object-side surface of the first lens element to the image surface is TL, a maximum image height of the optical lens system is ImgH, and the following condition is satisfied:
$$2.5 < TL / ImgH < 5.5 .$$

19. The optical lens system of claim 15, wherein the image-side surface of the fourth lens element comprises at least one inflection point, a distance in parallel with the optical axis between a maximum effective radius position of an optically effective area of the object-side surface of the fourth lens element to a maximum effective radius position of an optically effective area of the image-side surface of the fourth lens element is ET4, a central thickness of the fourth lens element is CT4, and the following condition is satisfied:
$$0. 75 < ET 4 / CT 4 < 2.00 .$$

20. The optical lens system of claim 15, wherein the object-side surface of the sixth lens element comprises at least one inflection point, a maximum image height of the optical lens system is ImgH, a maximum effective radius of the image-side surface of the sixth lens element is Y6R2, and the following condition is satisfied:
$$1. 20 < ImgH / Y 6 R 2 < 2.20 .$$

21. The optical lens system of claim 15, wherein the focal length of the optical lens system is f, half of a maximum field of view of the optical lens system is HFOV, and the following condition is satisfied:
$$0. mm < f / tan ( HFOV ) < 1. mm .$$

22. The optical lens system of claim 15, wherein at least two of the six lens elements are made of plastic material, the object-side surface and the image-side surface of each of at least two of the six lens elements are aspheric.

23. An optical lens system comprising six lens elements from an object side to an image side, the six lens elements being, in order from the object side to the image side:
a first lens element, a second lens element, a third lens element, a fourth lens element, a fifth lens element and a sixth lens element; each of the six lens elements has an object-side surface towards the object side and an image-side surface towards the image side;
wherein the image-side surface of the second lens element is concave in a paraxial region thereof;
the image-side surface of the third lens element is convex in a paraxial region thereof;
the image-side surface of the fourth lens element is concave in a paraxial region thereof;
the object-side surface of the fifth lens element is convex in a paraxial region thereof; and
the image-side surface of the sixth lens element comprises at least one inflection point;
wherein a focal length of the optical lens system is f, a focal length of the first lens element is f1, a composite focal length of the first lens element and the second lens element is f12, a central thickness of the first lens element is CT1, a central thickness of the sixth lens element is CT6, an axial distance between the first lens element and the second lens element is T12, a curvature radius of the object-side surface of the sixth lens element is R11, an axial distance between the object-side surface of the first lens element to the image-side surface of the sixth lens element is TD, an axial distance between the object-side surface of the first lens element to an image surface is TL, and the following conditions are satisfied:
$$0.25 < ( C T 1 + T 12 ) / TD < 0.4 ; \\ - 1.6 < \vert R 11 \vert / f 12 < - 0.5 ; \\ 1. < f / CT 1 < 2.3 ; \\ - 0.4 < f 1 / TL < 0. ; and \\ 10 < TD / CT 6 < 21 .$$

24. The optical lens system of claim 23, wherein the first lens element has negative refractive power, the image-side surface of the first lens element is concave in a paraxial region thereof; the third lens element has positive refractive power, the object-side surface of the third lens element is convex in a paraxial region thereof.

25. The optical lens system of claim 23, wherein an f-number of the optical lens system is Fno, and the following condition is satisfied:
$$1. 5 < Fno < 2.1 .$$

26. The optical lens system of claim 23, wherein the composite focal length of the first lens element and the second lens element is f12, an axial distance between the image-side surface of the sixth lens element and the image surface is BL, and the following condition is satisfied:
$$- 1.5 < f 12 / BL < - 0.1 .$$

27. The optical lens system of claim 23, wherein a central thickness of the second lens element is CT2, a central thickness of the fourth lens element is CT4, and the following condition is satisfied:
$$0.65 < CT 2 / CT 4 < 1.70 .$$

28. The optical lens system of claim 23, wherein the curvature radius of the object-side surface of the sixth lens element is R11, a curvature radius of the image-side surface of the sixth lens element is R12, and the following condition is satisfied:
$$- 35 < ( R 11 + R 12 ) / ( R 11 - R 12 ) < 0.5 .$$

29. The optical lens system of claim 23, wherein an Abbe number of the second lens element is V2, an Abbe number of the third lens element is V3, and the following condition is satisfied:
$$0.75 < V 2 / V 3 < 1.32 .$$

30. The optical lens system of claim 23, wherein the focal length of the optical lens system is f, the focal length of the first lens element is f1, the composite focal length of the first lens element and the second lens element is f12, the central thickness of the first lens element is CT1, the central thickness of the sixth lens element is CT6, the axial distance between the first lens element and the second lens element is T12, a curvature radius of the image-side surface of the fifth lens element is R10, the curvature radius of the object-side surface of the sixth lens element is R11, an axial distance between the second lens element and the third lens element is T23, an axial distance between the fourth lens element and the fifth lens element is T45, the axial distance between the object-side surface of the first lens element to the image-side surface of the sixth lens element is TD, the axial distance between the object-side surface of the first lens element to the image surface is TL, and the following conditions are satisfied:
$$0.28 \leq ( C T 1 + T 12 ) / TD \leq 0.37 ; \\ 0.39 \leq R 11 / R 10 \leq 0.96 ; \\ 6.74 \leq TL / f \leq 10.11 ; \\ - 4.72 \leq f 1 / CT 1 \leq - 2.85 ; \\ - 1.16 \leq \vert R 11 \vert / f 12 \leq - 0.67 ; \\ 0.06 \leq T 45 / T 23 \leq 0.28 ; \\ 1. 30 \leq f / CT 1 \leq 2.02 ; \\ - 0.29 \leq f 1 / TL \leq - 0.25 ; and$$
$$12.16 \leq TD / CT 6 \leq 16.65 .$$
